(19) United States
(12) Patent Application Publication
(10) Pub. No.: US 2012/0179522 A1
(43) Pub. Date: Jul. 12, 2012

(54) ADVERTISEMENT DISTRIBUTION DEVICE, TERMINAL, ADVERTISEMENT DISTRIBUTION SYSTEM, ADVERTISEMENT DISTRIBUTION METHOD, AND DATA PROCESSING METHOD

(75) Inventors: Kazufumi Adachi, Hachiouji (JP); Hironori Nagayama, Yokohama (JP); Kazuya Shiina, Saitama (JP); Hideki Katayama, Shinagawa-ku (JP); Hiroshi Suzuki, Kawasaki (JP); Shigenori Suzuki, Meguto (JP)

(73) Assignees: PIONEER SOLUTIONS CORPORATION, KAWASAKI-SHI (JP); PIONEER CORPORATION, KAWASAKI-SHI (JP)

(21) Appl. No.: 13/497,121

(22) PCT Filed: Oct. 1, 2009
(86) PCT No.: PCT/JP2009/067156

§ 371 Date: Mar. 20, 2012

(51) Int. Cl. G06Q 30/02

(52) U.S. Cl. 705/14.4

(57) ABSTRACT

A server of an advertisement distribution system allows downloading of content data in response to a request of a terminal and makes the terminal periodically download shared content managing information. Then, when the server recognizes that the content data stored in a server storage before the server storage goes out of order has to be stored in a new server storage (restoration process), the server makes the terminal upload the shared content managing information and acquires from the terminal the content data specified by the shared content managing information to store the content data in the new server storage.

### TECHNICAL FIELD

The present invention relates to a data distribution device, a data processing device, a data processing system, a data distribution method and a data processing method.

### BACKGROUND ART

An arrangement of a client-server system in which a server sends data to a client and the client registers the data is conventionally known (see, for instance, Patent Literature 1).

When data is registered by a management terminal, the server of the client-server system divides the data and registers the data in respective clients. Then, when a harddisk goes out of order, the server executes a restore command after the harddisk is repaired. The restore command allows the server to receive all the data registered in the respective clients and merge the data to restore the data.

### CITATION LIST

### Patent Literature

[PTL 1] JP-A-10-214160

### SUMMARY OF INVENTION

### Technical Problem

However, according to the arrangement disclosed in Patent Literature 1, when the number of the clients is changed, the data has to be divided in different number, so that the control for the division processing becomes complicated. Further, even when only one of the clients is out of order, a part of the divided data cannot be retrieved, thereby failing to restore the data. In addition, it is possible that old data that is not necessary for the restoration of the server may be sent from the clients, so that the data may not be properly restored.

An object of the present invention is to provide a data distribution device, a data processing device, a data processing system, a data distribution method and a data processing method that can appropriately restore a distributor storage with a simple control.

### Solution to Problem

A data distribution device according to an aspect of the invention is connected via a network to a plurality of data processing devices configured to process distribution data, the data distribution device distributing the distribution data stored in a distributor storage to the plurality of data processing devices, the data distribution device including: a distribution data distributor that is configured to acquire the distribution data from the distributor storage and to distribute the distribution data to the plurality of data processing devices; a management information distributor that is configured to distribute distribution data management information that is configured to specify the distribution data stored in the distributor storage to the plurality of data processing devices; a distribution-side management information acquirer that, upon recognizing that the distribution data specifiable by the distribution data management information is necessary to be stored in a restoration target storage provided by the distributor storage or another distributor storage, is configured to acquire the distribution data management information from the plurality of data processing devices; and a storage controller that is configured to acquire the distribution data specified based on the distribution data management information acquired by the distribution-side management information acquirer and to store the distribution data in the restoration target storage.

A data processing device according to another aspect of the invention is connected to a data distribution device configured to distribute distribution data stored in a distributor storage via a network, the data processing device processing the distribution data, the data processing device including: a distribution data accumulating unit that is configured to acquire the distribution data from the data distribution device and to store the distribution data in a processing-side storage; a processing-side management information acquirer that is configured to acquire from the data distribution device distribution data management information that is configured to specify the distribution data stored in the distributor storage and to store the distribution data management information in the processing-side storage; a distribution data returning unit that, when it is necessary to store the distribution data specifiable by the distribution data management information in a restoration target storage provided by the distributor storage or another distributor storage, is configured to return the distribution data management information stored in the processing-side storage to the data distribution device; a restoration status information acquirer that is configured to acquire restoration status information relating to a storing status of the distribution data in the restoration target storage from the data processing device; and a restoration procedure controller that is configured to send the distribution data that is stored in the processing-side storage but not stored in the restoration target storage to the data distribution device based on the restoration status information.

A data processing system according to still another aspect of the invention includes: a plurality of data processing devices that are configured to process distribution data; and the data distribution device according to claim 1, the data distribution device being connected to the plurality of data processing devices via a network, in which the data processing devices each include: a distribution data accumulating unit that is configured to acquire the distribution data from the data distribution device and to store the distribution data in a processing-side storage; a processing-side management information acquirer that is configured to acquire the distribution data management information from the data distribution device and to store the distribution data management information in the processing-side storage; a distribution data returning unit that is configured to return the distribution data management information stored in the processing-side storage to the data distribution device when it is necessary to store the distribution data specifiable by the distribution data management information in the restoration target storage; and a restoration procedure controller that is configured to send the distribution data stored in the processing-side storage to the data distribution device.

A data distribution method according to a further aspect of the invention uses a computer, connected to a plurality of data processing devices configured to process distribution data via a network, to distribute the distribution data stored in a distributor storage to the plurality of data processing devices, the method including: distributing, after acquiring the distribution data from the distributor storage, the distribution data to the plurality of data processing devices; distributing distribution data management information that is configured to specify the distribution data stored in the distributor storage to the plurality of data processing devices; upon recognizing that the distribution data specifiable by the distribution data management information is necessary to be stored in a restoration target storage provided by the distributor storage or another distributor storage, acquiring the distribution data management information from the plurality of data processing devices; and after acquiring the distribution data specified based on the distribution data management information acquired by the acquiring the distribution data management information, storing the distribution data in the restoration target storage.

A data processing method according to still further aspect of the invention uses a computer, connected to a data distribution device configured to distribute distribution data stored in a distributor storage via a network, to process the distribution data, the method including: after acquiring the distribution data from the data distribution device, storing the distribution data in a processing-side storage; after acquiring from the data distribution device distribution data management information that is configured to specify the distribution data stored in the distributor storage, storing the distribution data management information in the processing-side storage; when it is necessary to store the distribution data specifiable by the distribution data management information in a restoration target storage provided by the distributor storage or another distributor storage, returning the distribution data management information stored in the processing-side storage to the data distribution device; acquiring restoration status information relating to a storing status of the distribution data in the restoration target storage from data processing devices; and sending the distribution data that is stored in the processing-side storage but not stored in the restoration target storage to the data distribution device based on the restoration status information.

A data processing method according to still further aspect of the invention uses a plurality of first computers that are configured to process distribution data; and a second computer that is connected to the plurality of first computers via a network, the method including: distributing, by the second computer, the distribution data to the plurality of first computers after acquiring the distribution data from a distributor storage; distributing, by the second computer, distribution data management information that is configured to specify the distribution data stored in the distributor storage to the plurality of first computers; upon recognizing that the distribution data specifiable by the distribution data management information is necessary to be stored in a restoration target storage provided by the distributor storage or another distributor storage, acquiring the distribution data management information from the plurality of first computers by the second computer; after acquiring the distribution data specified based on the distribution data management information acquired by the acquiring the distribution data management information from the first computers, storing the distribution data in the restoration target storage by the second computer; after acquiring the distribution data from the second computer, storing the distribution data in a processing-side storage by the first computers; after acquiring the distribution data management information from the second computer, storing the distribution data management information in the processing-side storage by the first computers; when it is necessary to store in the restoration target storage the distribution data specifiable by the distribution data management information, returning, by the first computers, the distribution data management information stored in the processing-side storage to the second computer; and sending the distribution data stored in the processing-side storage to the second computer by the first computers.

### BRIEF DESCRIPTION OF DRAWINGS

FIG. 1 is a block diagram of an advertisement distribution system according to first, second and third exemplary embodiments of the invention.

FIG. 2 is a block diagram of a server according to the first exemplary embodiment.

FIG. 2 schematically shows a storing status in a server storage according to the first exemplary embodiment.

FIG. 4 schematically shows a construction of shared content managing information according to the first, second and third exemplary embodiments.

FIG. 5 is a block diagram of a terminal according to the first, second and third exemplary embodiments.

FIG. 6 schematically shows a storing status in a terminal storage according to the first exemplary embodiment.

FIG. 7 is a flowchart showing an operation of a terminal in a restoration process according to the first exemplary embodiment.

FIG. 8 is a flowchart showing an operation of the terminal in the restoration process according to the first to third exemplary embodiments.

FIG. 9 is a flowchart showing an operation of the server in the restoration process according to the first exemplary embodiment.

FIG. 10 is a flowchart showing an operation of the server in the restoration process according to the first exemplary embodiment.

FIG. 11 is a flowchart showing an operation of the server in the restoration process according to the first exemplary embodiment.

FIG. 12 is a block diagram of a server according to the second exemplary embodiment.

FIG. 13 schematically shows a storing status of a server storage according to the second exemplary embodiment.

FIG. 14 schematically shows a construction of restoration managing information according to the second exemplary embodiment.

FIG. 15 schematically shows a storing status in a terminal storage according to the second exemplary embodiment.

FIG. 16 is a flowchart showing an operation of a terminal in a restoration process according to the second exemplary embodiment.

FIG. 17 is a flowchart showing an operation of the server in the restoration process according to the second exemplary embodiment.

FIG. 18 is a flowchart showing an operation of the server in the restoration process according to the second exemplary embodiment.

FIG. 19 is a block diagram of a server according to the third exemplary embodiment.

FIG. 20 schematically shows a storing status of a server storage according to the third exemplary embodiment.

FIG. 21 schematically shows a storing status in a terminal storage according to the third exemplary embodiment.

FIG. 22 is a flowchart showing an operation of a terminal in a restoration process according to the third exemplary embodiment.

FIG. 23 is a flowchart showing an operation of the server for generating upload target information according to the third exemplary embodiment.

FIG. 24 is a flowchart showing an operation of the server in the restoration process according to the third exemplary embodiment.

FIG. 25 is a flowchart showing an operation of the server in the restoration process according to the third exemplary embodiment.

### DESCRIPTION OF EMBODIMENTS

First to third exemplary embodiments of the invention will be described below. Incidentally, in the first to third exemplary embodiments, an arrangement in which a content distributed from a server is reproduced by a terminal and, when a server storage of the server is out of order, various data stored in the server storage before going out of order is retrieved from the terminal to store the data in a new server storage will be exemplarily explained. In the following description, a process for retrieving the various data stored in the server storage before going out of order and storing the data in the new server storage will be referred to as a restoration process of the server storage.

### First Exemplary Embodiment

Initially, a first exemplary embodiment of the invention will be described below.

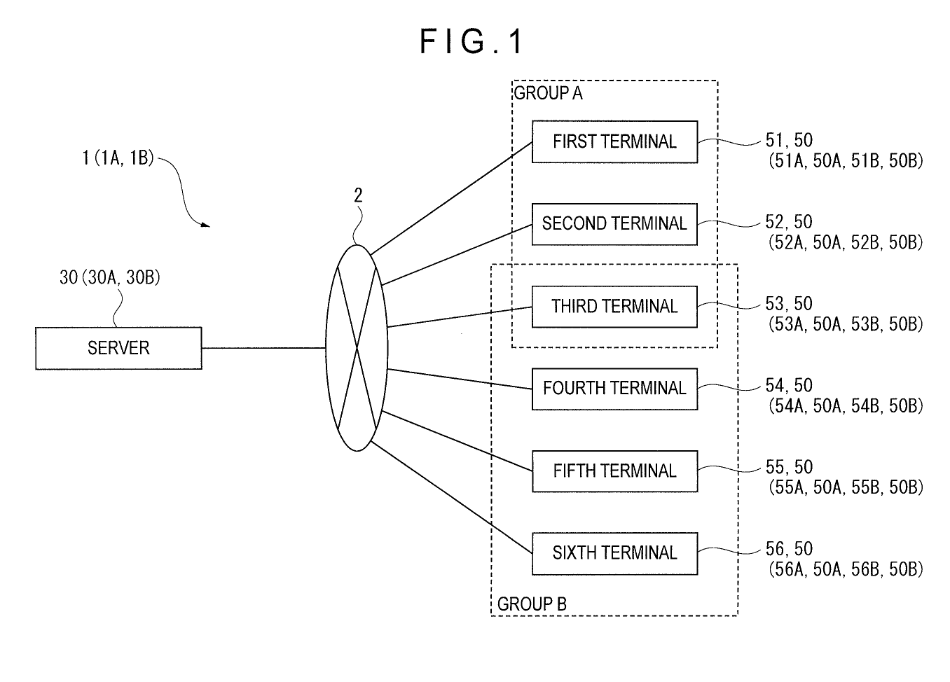

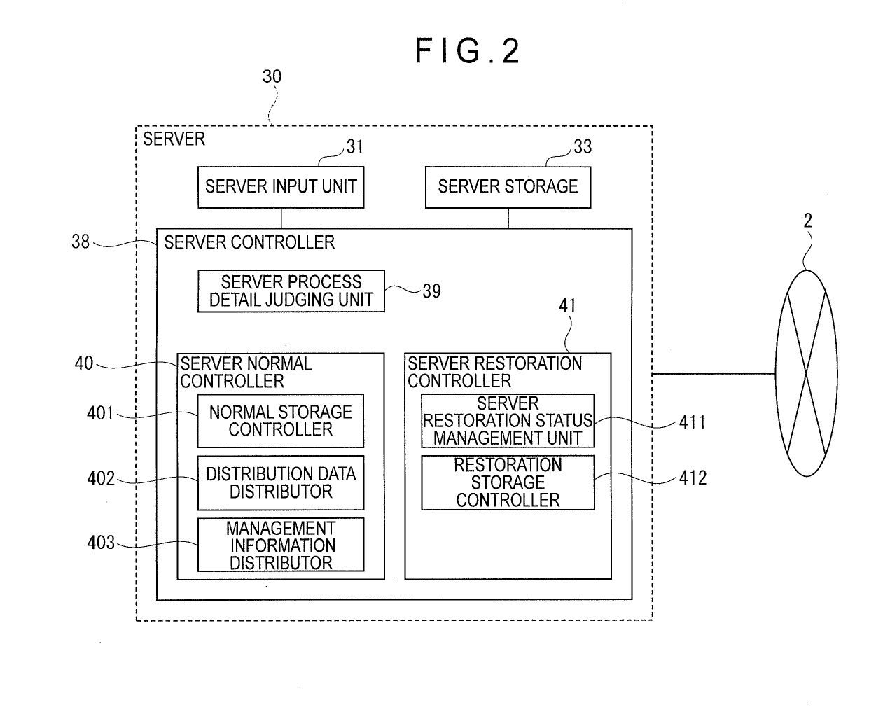

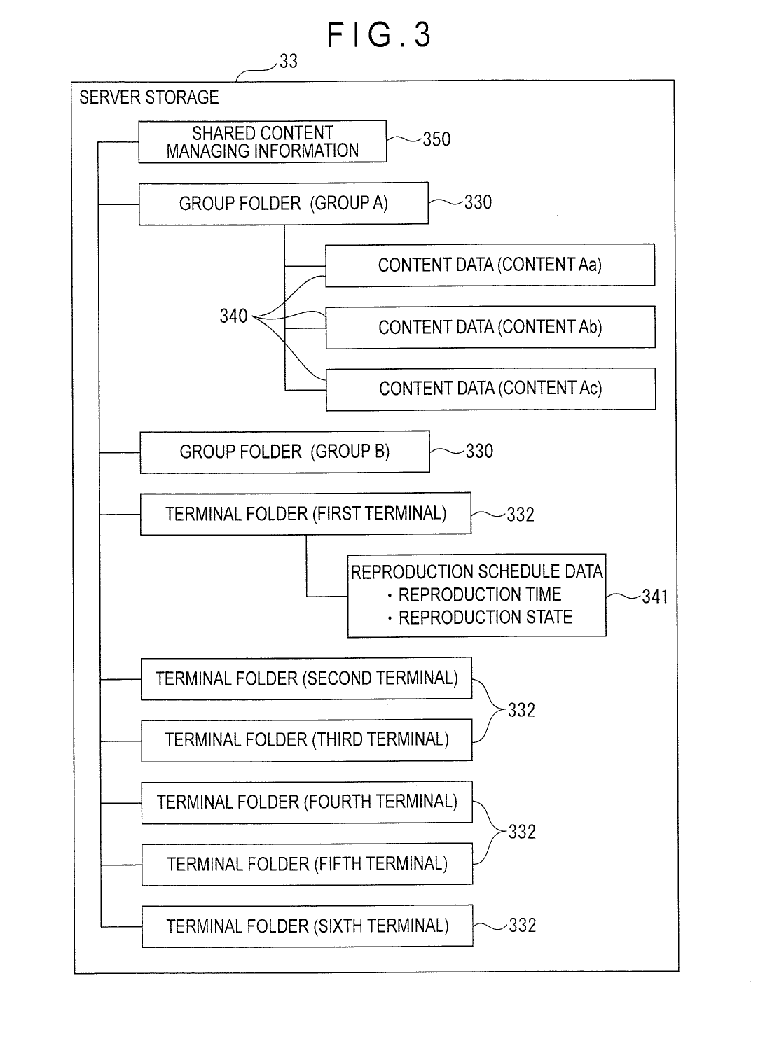

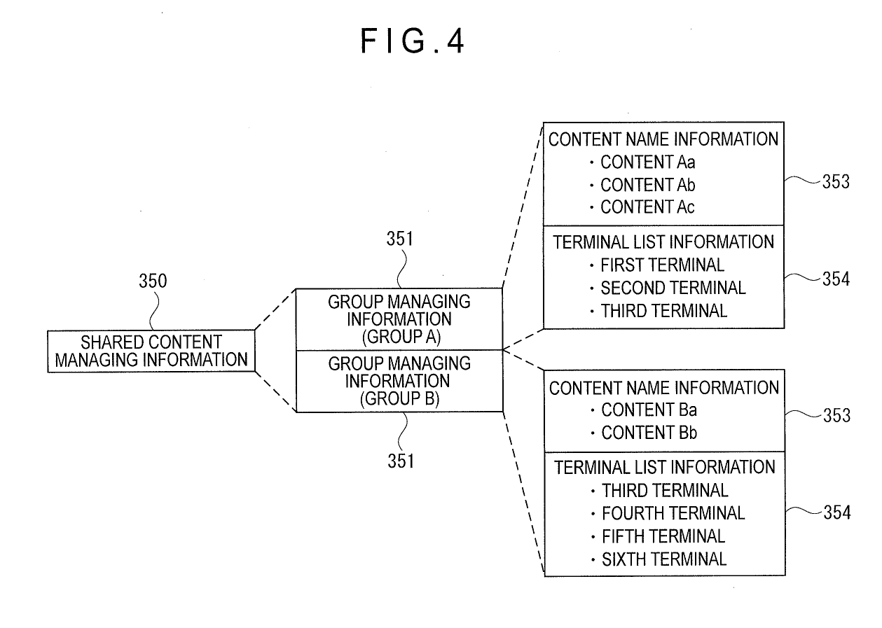

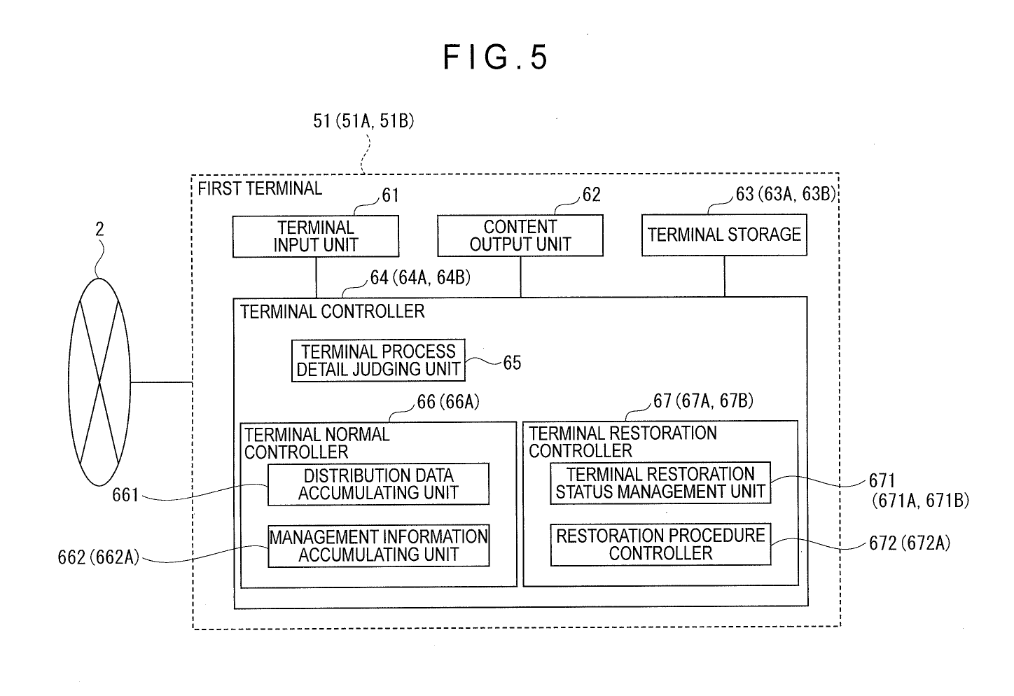

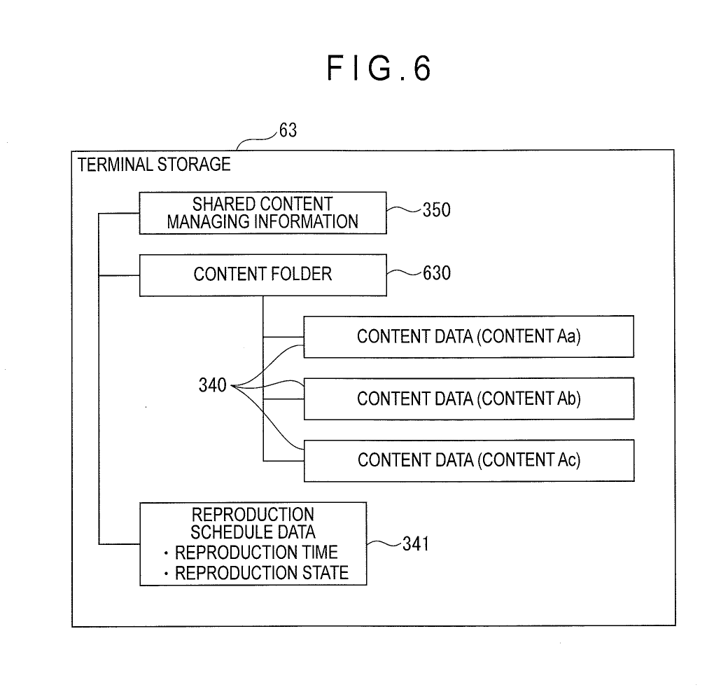

FIG. 1 is a block diagram of an advertisement distribution system according to first, second and third exemplary embodiments of the invention. FIG. 2 is a block diagram of the server. FIG. 3 schematically shows a storing status of the server storage. FIG. 4 schematically shows a construction of shared content managing information. FIG. 5 is a block diagram of the terminal. FIG. 6 schematically shows a storing status of a terminal storage.

Arrangement of Advertisement Distribution System

Initially, an arrangement of the advertisement distribution system will be described below.

As shown in FIG. 1, an advertisement distribution system 1 (data processing system) includes a network 2, a server 30 (data distribution device) and first, second, third, fourth, fifth and sixth terminals (data processing device) 51, 52, 53, 54, 55 and 56.

The first to third terminals 51 to 53 belong to a group A for reproducing advertising contents Aa, Ab and Ac. The third to sixth terminals 53 to 56 belong to a group B for reproducing advertising contents Ba and Bb. Examples of the group include those provided by the same company, the same affiliate company, each of local areas and group of friends. The number of the group may alternatively be one or more than two. The number of terminals constituting each of the groups is not restricted as long as a plurality of terminals are provided. The number of contents reproduced by each of the groups may alternatively more than the number mentioned above.

The network 2 connects the server 30 and the first to sixth terminals 51 to 56 in a manner capable of transmitting various information.

Incidentally, when the first to sixth terminals 51 to 56 are collectively referred to, they are represented as a terminal 50.

As shown in FIG. 2, the server 30 (a second computer) includes a server input unit 31, a server storage 33 serving as a distributor storage and a restoration target storage, and a server controller 38.

The server input unit 31 is operated by an administrator or an operator and outputs a signal concerning a content inputted by the operation to the server controller 38.

As shown in FIG. 3, the server storage 33 is provided with group folders 330 corresponding to each of the groups A and B and terminal folders 332 corresponding to each of the first to sixth terminals 51 to 56.

The group folder 330 of the group A stores content data 340 constituting distribution data of contents Aa, Ab and Ac to be distributed to the first to third terminals 51 to 53 belonging to the group A. The content data 340 is provided by image data, audio data and text (caption) data. The group folder 330 of the group B stores content data (not shown) constituting distribution data of contents Ba and Bb to be distributed to the third to sixth terminals 53 to 56 belonging to the group B.

A terminal folder 332 of the first terminal stores data to be distributed only to the first terminal 51. Specifically, the terminal folder 332 stores reproduction schedule data 341 as process schedule data constituting the distribution data. The reproduction schedule data 341 is recorded with reproduction time of the contents Aa, Ab and Ac on the first terminal 51, reproduction status relating to a display position of the contents Aa, Ab and Ac etc, and the like. The terminal folders 332 of the second to sixth terminals are also recorded with reproduction schedule data (not shown) relating to the reproduction of the contents on the second to sixth terminals 52 to 56.

The server storage 33 is recorded with shared content managing information 350 (distribution data management information) to be used for restoration process of the server storage 33. As shown in FIG. 4, the shared content managing information 350 is provided with group managing information 351 relating to each of all of the groups (the groups A and B in this exemplary embodiment) belonging to the advertisement distribution system 1. The group managing information 351 includes content name information 353 in which content name of the contents to be reproduced in each of the groups is recorded and terminal list information 354 in which the name of the terminal 50 belonging to each of the groups is recorded. Further, the shared content managing information 350 includes timestamp information (not shown) relating to time and date when the shared content managing information 350 is generated or updated.

As shown in FIG. 2, the server controller 38 is provided by various programs including server process detail judging unit 39, a server normal controller 40 and a server restoration controller 41.

The server process detail judging unit 39 judges, in response to query polling for new content from the terminal 50, whether the server storage 33 is in a normal state (i.e. a state in which the server storage 33 is not out of order and content data 340 and the like is downloadable from the server storage 33) or in a restoration state (i.e. a state in which the server storage is out of order or the server storage is in trouble so that the content data 340 has to be stored in a new server storage 33). When the server storage 33 is in the normal state, server process detail judging unit 39 sends a normal process request indicating that the content data 340 and the like is downloadable to the terminal 50 and proceed the process by the server normal controller 40. On the other hand, when the server storage 33 is in the restoration state, the server process detail judging unit 39 sends a restoration request signal to the terminal 50 and proceed the process by the server restoration controller 41.

The server normal controller 40 executes a process in the normal state. The server normal controller 40 includes a normal storage controller 401, a distribution data distributor 402 and a management information distributor 403.

When the content data 340 is uploaded from an advertiser server (not shown), the normal storage controller 401 stores the content data 340 in the group folder 330 in the server storage 33. Further, when the reproduction schedule data 341 relating to the stored content data 340 is uploaded by the advertiser server, the normal storage controller 401 stores the content data in the terminal folder 332. The normal storage controller 401 updates the reproduction schedule data 341 in response to a request from the advertiser server. Incidentally, the reproduction schedule data 341 may be generated according to an input operation on the server input unit 31.

The distribution data distributor 402 allows downloading of the content data 340 and the reproduction schedule data 341 as distribution data in response to a request from the terminal 50. Specifically, when information on, for example, the name of the first terminal 51 and the group to which the first terminal 51 belongs is sent from the first terminal 51 in response to the normal process request, the distribution data distributor 402 recognizes that the content data 340 to be distributed to the first terminal 51 is the contents Aa, Ab and Ac based on content name information 353 of the shared content managing information 350. Further, when the distribution data distributor 402 recognizes that one of the contents Aa, Ab and Ac has not been downloaded, the distribution data distributor 402 allows the downloading of the undownloaded content data. Further, the distribution data distributor 402 allows the downloading of the reproduction schedule data 341 in the terminal folder 332 of the first terminal 51 to the first terminal 51. On the other hand, when the distribution data distributor 402 recognizes that all of the content data 340 of the contents Aa, Ab and Ac have been downloaded, the distribution data distributor 402 does not allow downloading of the content data 340 and the reproduction schedule data 341. Incidentally, it is preferable that the content data 340 and the reproduction schedule data 341 are downloaded after being encrypted.

The management information distributor 403 makes the first to sixth terminals 51 to 56 download the shared content managing information 350. Specifically, the management information distributor 403 generates shared content managing information 350 reflecting a storing status of each of data in the server storage 33. Further, when new content data 340 is stored or when reproduction schedule data 341 is stored or updated, the management information distributor 403 recognizes the group remaining after the data is stored or updated, the name of the content to be downloaded by each of the groups and the name of terminal(s) belonging to each of the groups. Then, when there is a newly recognized group, the management information distributor 403 generates the shared content managing information 350 including the group managing information 351 relating to the group. When the name of the contents to be distributed or the name of the terminal(s) belonging to the group(s) is changed without the presence of newly recognized group, the content name information 353 and the terminal list information 354 are updated. The management information distributor 354 periodically makes the first to sixth terminals 51 to 56 recorded in the terminal list information 354 download the shared content managing information 350. In other words, the management information distributor 354 makes the first to sixth terminals 51 to 56 download the common shared content managing information 350 by.

The server restoration controller 41 executes a process in the restoration state. The server restoration controller 41 includes a server restoration status management unit 411 (restoration status information generator) and a restoration storage controller 412 (storage controller) serving also as distribution-side management information acquirer.

The server restoration status management unit 411 manages a restoration status in the restoration state. Specifically, when the server restoration status management unit 411 recognizes the restoration state, the server restoration status management unit 411 generates empty (i.e. without storing data) shared content managing information 350 as restoration status information. Then, when a query polling for a new content is received from, for example, the first terminal 51, the server restoration status management unit 411 records the name of the first terminal 51 in the terminal list information 354 of the group A in restoration management information and makes the first terminal 51 download the restoration status information. The restoration status information is used when the terminals 51 to 56 select content data 340 to be uploaded to the server 30.

Further, when the content data 340 from the terminal 50 is stored in the server storage 33 by the restoration storage controller 412, the server restoration status management unit 411 records the name of the stored content data 340 in the content name information 353 of the restoration management information.

When the content data 340 or the reproduction schedule data 341 is uploaded from the terminal 50, the restoration storage controller 412 recognizes the group corresponding to the content data 340 and the terminal 50 from which the reproduction schedule data 341 is sent based on the new content query polling. Then, the restoration storage controller 412 generates the group folder 330 and the terminal folder 332 as necessary to store the content data 340 and the reproduction schedule data 341.

Further, when the shared content managing information 350 is uploaded from the terminal 50, the restoration storage controller 412 stores the shared content managing information 350 in the server storage 33. When the shared content managing information 350 is uploaded while the shared content managing information 350 is stored in the server storage 33, one of the shared content managing information 350 with an earlier timestamp is stored in the server storage 33.

Further, when the restoration storage controller 412 recognizes that an upload completion notification indicating that uploading of the content data 340, the reproduction schedule data 341 and the shared content managing information 350 is completed is received from all the terminals 50 recorded in the shared content managing information 350, the restoration storage controller 412 terminates the restoration process of the server storage 33.

The first terminal 51 (first computer) is located at, for example, a facility such as a movie theater and a shop. As shown in FIG. 5, the first terminal 51 includes a terminal input unit 61, content output unit 62, a terminal storage 63 (processing-side storage) and a terminal controller 64. It should be noted that the first to sixth terminals 51 to 56 have the same arrangement.

The terminal input unit 61 is controlled according to reproduction schedule data and outputs a signal concerning a content inputted by the control to the terminal controller 64.

The content input unit 62 includes a display (not shown) for displaying an image of the content of the content data 340 and an audio output unit (not shown) that outputs sound under the control of the terminal controller 64. Examples of the display includes a liquid crystal panel, organic EL (Electro Luminescence) panel, PDP (Plasma Display Panel), CRT (Cathode Ray Tube), FED (Field Emission Display) and electrophoretic display panel disposed in the above facility.

As shown in FIG. 6, the terminal storage 63 is provided with a content folder 630. The content folder 630 stores the content data 340 for the group A when the terminal 50 belongs to the group A as shown in FIG. 6. On the other hand, when the terminal 50 belongs to the group B, the content folder 630 stores the content data 340 for the group B. Further, the terminal storage 63 stores the shared content managing information 350 and the reproduction schedule data 341.

As shown in FIG. 5, the terminal controller 64 is provided by various programs including terminal process detail judging unit 65, a terminal normal controller 66 and a terminal restoration controller 67.

The terminal process detail judging unit 65 makes a query polling for new content per N (N being a natural number) hour(s). The query polling for new content includes information on the terminal 50 from which the polling is sent and information on the group to which the terminal 50 belongs. When the normal process request is returned from the server 30, the process is performed by the terminal normal controller 66. When the restoration request is returned, the process is performed by the terminal restoration controller 67.

The terminal normal controller 66 executes a process in the normal state. The terminal normal controller 66 includes a distribution data accumulating unit 661 and a management information accumulating unit 662 as a processing-side management information acquirer.

The distribution data accumulating unit 661 acquires the content data 340 and the reproduction schedule data 341 downloaded from the server 30 as distribution data and stores the content data 340 and the reproduction schedule data 341 in the terminal storage 63. Specifically, when the normal process request is returned from the server 30, the distribution data accumulating unit 661 sends to the server 30 the information relating to the terminal 50 and the information relating to the group to which the terminal 50 belongs. Then, the distribution data accumulating unit 661 downloads the content data 340 and the reproduction schedule data 341 from the server 30 and stores the content data 340 and the reproduction schedule data 341 in, for instance, the server storage 33 as shown in FIG. 6.

The management information accumulating unit 662 periodically downloads the shared content managing information 350 and stores the shared content managing information 350 in the terminal storage 63.

The terminal restoration controller 67 executes a process in the restoration state. The terminal normal controller 67 includes a terminal restoration status management unit 671 (a restoration status information acquirer) and a restoration procedure controller 672 (a distribution data returning unit).

When a restoration request is returned from the server 30, the terminal restoration status management unit 671 downloads the restoration status information from the server 30. Then, the terminal restoration status management unit 671 selects from the content data 340 stored in the terminal storage 63 the content data 340 not recorded in the restoration status information as upload target data. Incidentally, the terminal restoration status management unit 671 may select a part of the content data 340 of the group A recorded in the content name information 353 of the shared content managing information 350 stored in the terminal storage 63 but not recorded in the restoration status information as the upload target data.

The restoration procedure controller 672 uploads to the server 30 the content data 340 selected by the terminal restoration status management unit 671 as the upload target data. The restoration procedure controller 672 uploads the reproduction schedule data 341 and the shared content managing information 350 to the server 30 when the reproduction schedule data 341 and the shared content managing information 350 are not uploaded to the server 30.

Operation of Advertisement Distribution System

Next, the operations of the first terminal 51 and the server 30 will be mainly described for explaining the operation of the advertisement distribution system. Incidentally, the operations of the first terminal 51 and the server 30 will be separately described below.

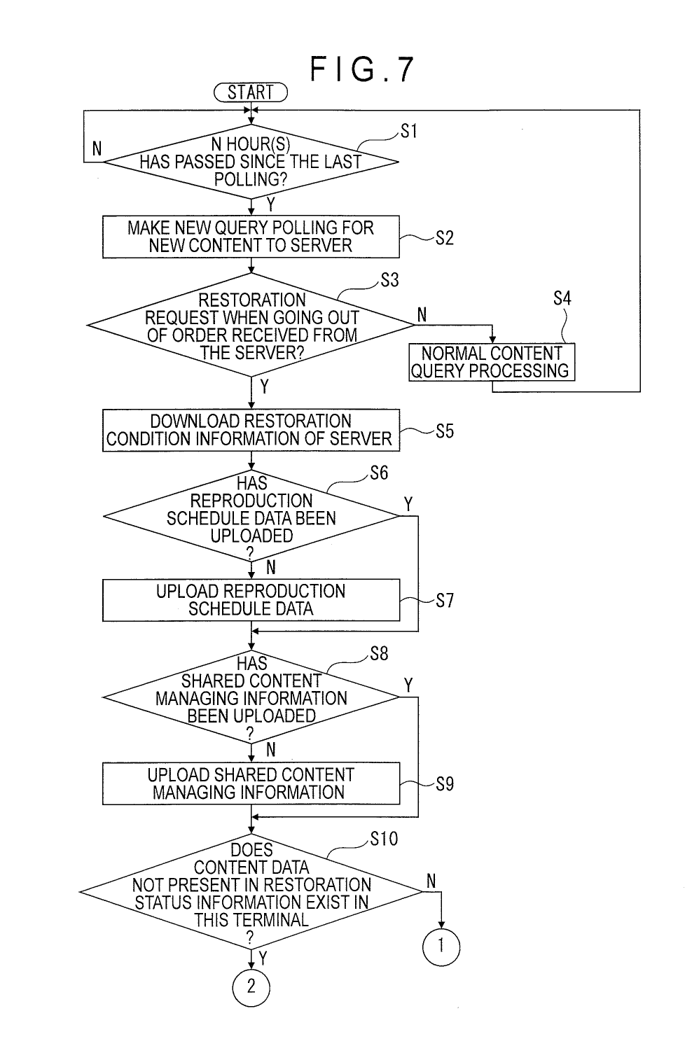

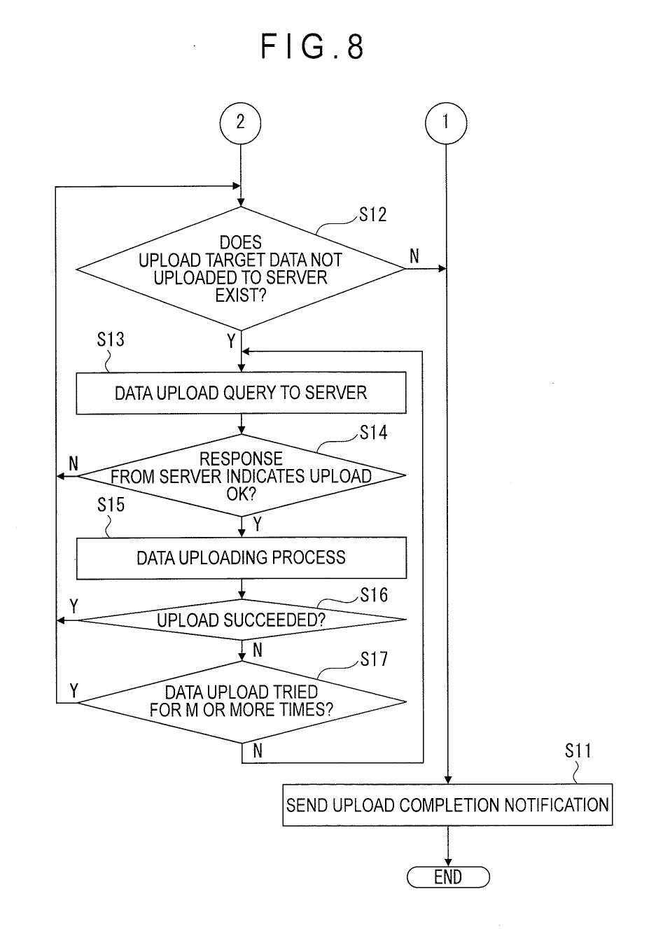

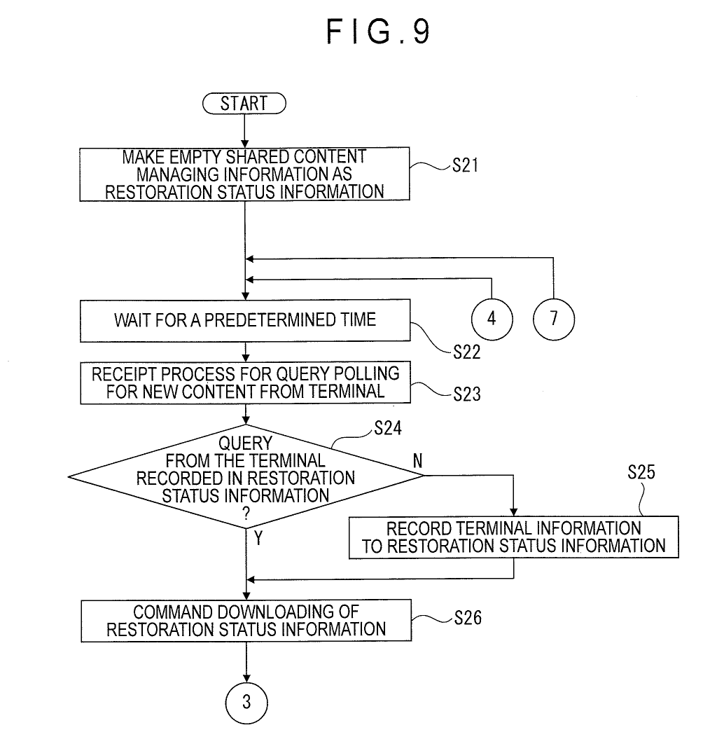

FIGS. 7 and 8 are flowcharts showing the operation of the terminal in the restoration process. FIGS. 9 to 11 are flowcharts showing the operation of the server in the restoration process.

The terminal controller 64 of the first terminal 51 judges by the terminal process detail judging unit 65 whether or not N hour has passed since the preceding query polling for new content as shown in FIG. 7 (Step S1). Then, when it is determined in Step S1 that N hour has not passed, the process in Step 1 is performed after passing a predetermined time. On the other hand, when it is determined that N hour has passed, the terminal process detail judging unit 65 makes the query polling for new content to the server 30 (Step S2). Subsequently, the terminal process detail judging unit 65 judges whether or not a restoration request according to the process in Step S23 (described below) is returned from the server 30 (Step S3).

In Step S3, when it is judged that a normal process request is returned from the server 30 instead of a restoration request, the terminal normal controller 66 sends information relating to the first terminal 51 to the server 30 in order to download the content data 340 and the like. In other words, a normal content query process is performed (Step S4). Then, the terminal controller 64 performs the process in Step S1. On the other hand, when it is judged that a restoration request is returned in Step S4, the terminal restoration status management unit 671 downloads restoration status information from the server 30 (Step S5).

Subsequently, the restoration procedure controller 672 of the terminal restoration controller 67 judges whether the reproduction schedule data 341 of the terminal storage 63 has been uploaded or not (Step S6). When the reproduction schedule data 341 has not been uploaded, the restoration procedure controller 672 uploads the reproduction schedule data 341 (Step S7). Then, the restoration procedure controller 672 judges whether the shared content managing information 350 has been uploaded or not (Step S8) after the process in Step S7 or when it is determined that the reproduction schedule data 341 has been uploaded in Step S6. When the shared content managing information 350 has not been uploaded, the restoration procedure controller 672 uploads the shared content managing information 350 (Step S9).

Further, the terminal restoration status management unit 671 judges whether the content data 340 that is not recorded in the restoration status information to have been recorded in the server storage 33 is present in the terminal storage 63 of the first terminal 51 after the process in Step S9 or when it is determined in Step S8 that the shared content managing information 350 has been uploaded (Step S10).

In Step S10, when the terminal restoration status management unit 671 judges that no such content data 340 is present (i.e. when it is recorded in the restoration status information that all of the content data 340 in the terminal storage 63 is stored in the server storage 33), the terminal restoration status management unit 671 recognizes that the content data 340 to be uploaded to the server 30 does not exist and sends the upload completion notification to the server (Step S11) and terminates the process.

On the other hand, when it is determined that such content data 340 exists in Step S10 in FIG. 7, the terminal restoration status management unit 671 judges whether upload target data that is not uploaded to the server 30 exists among the content data not recorded in the restoration status information but stored in the terminal storage 63, as shown in FIG. 8 (Step S12). When it is determined that such content data 340 does not exist in Step S12, the terminal restoration status management unit 671 performs the process in Step S11 recognizing that all of the content data 340 not recorded in the restoration status information but stored in the terminal storage 63 has been uploaded to the server 30. When it is determined that such content data 340 exists in Step S12, the terminal restoration status management unit 671 makes the restoration procedure controller 672 send an upload query for the content data 340 to the server 30 (Step S13).

Then, the restoration procedure controller 672 judges whether or not a response permitting the upload from the server 30 has been received from the server 30 (Step S14). When the restoration procedure controller 672 receives a response indicating that upload is not possible according to a process in Step S38 (described below), the restoration procedure controller 672 performs the process in Step S12. When the restoration procedure controller 672 receives a response indicating that upload is possible, the restoration procedure controller 672 uploads the upload target data to the server 30 (Step S15). After the process in Step S15, the restoration procedure controller 672 judges whether the upload target data has been successfully uploaded or not (Step S16). When it is determined that the upload target data has been successfully uploaded, the restoration procedure controller 672 performs the process in Step S12. When it is determined that the uploading of the upload target data is failed, the restoration procedure controller 672 judges whether the uploading of the upload target data has been tried for M (M being a natural number) times or more (Step S17).

Then, when it is determined that the uploading of the upload target data has been tried for M times or more, the restoration procedure controller 672 performs the process in Step S12. When it is determined that the uploading of the upload target data has been tried for less than M times, the restoration procedure controller 672 performs the process in Step S13.

On the other hand, when server controller 38 of the server 30 recognizes the restoration state by the server restoration status management unit 411, the server controller 38 generates the empty shared content managing information 350 as the restoration status information as shown in FIG. 9 (Step S21) and wait for a predetermined time (Step S22). Subsequently, when the server process detail judging unit 39 of the server controller 38 receives the query polling for new content according to the above-described process in Step S2 from the terminal 50, the server process detail judging unit 39 performs a process for returning a restoration request to the terminal 50 (i.e. new content query polling receipt process) (Step S23).

Then, the server restoration status management unit 411 judges whether the polling is from the terminal 50 recorded in the restoration status information or not (Step S24).

In Step S24, when it is determined that the polling is not from the terminal 50 recorded in the restoration status information, the server restoration status management unit 411 records in the restoration status information the information relating to the terminal 50 from which the polling is sent (Step S25). Then, after Step S25 or when it is determined that the polling is from the terminal 50 recorded in the restoration status information, the server restoration status management unit 411 makes the terminal 50 from which the polling is sent perform the process in the above Step S5 to download the restoration status information (Step S26).

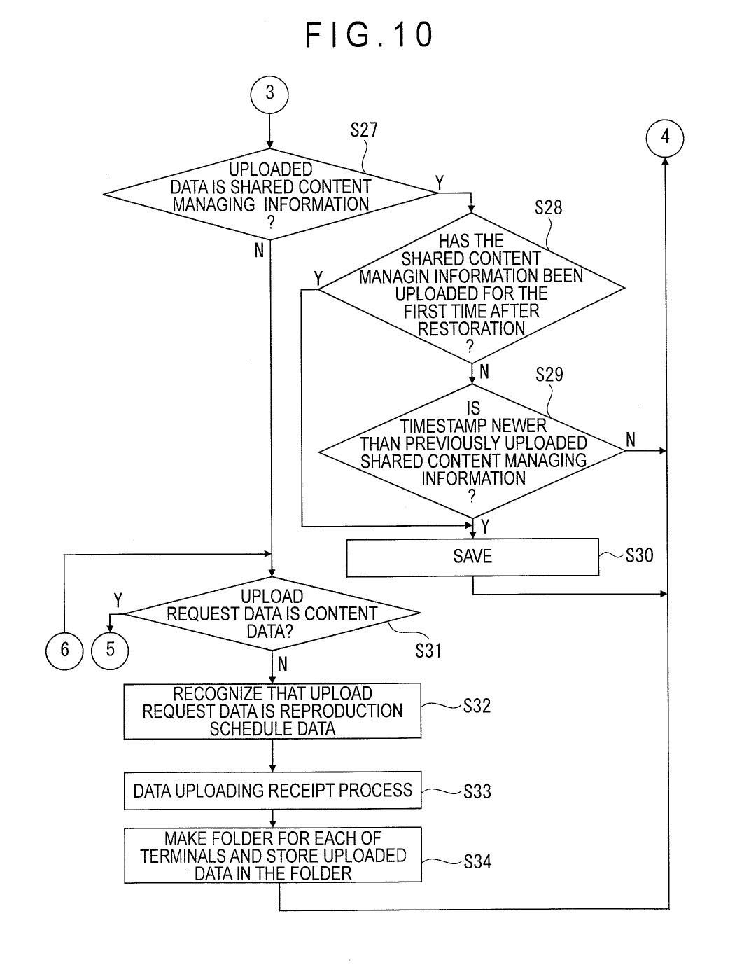

Subsequently, when data is uploaded from the terminal 50 from which the restoration status information is downloaded as shown in FIG. 10, the restoration storage controller 412 judges whether or not the data is the shared content managing information 350 according to the process in the above-described Step S9 (Step S27). When it is judged that the data is the shared content managing information 350 in Step S27, the restoration storage controller 412 judges whether or not the shared content managing information 350 is uploaded for the first time after the restoration (Step S28). In Step S28, when it is determined that the shared content managing information 350 is not uploaded for the first time after the restoration, whether or not the shared content managing information 350 has a timestamp earlier than that of the previously uploaded shared content managing information 350 is judged (Step S29). When it is determined that the newly uploaded shared content managing information 350 has an earlier timestamp, the newly uploaded shared content managing information 350 is saved in place of the old one (Step S30) to perform the process in Step S22. When it is judged that the shared content managing information 350 is uploaded for the first time after the restoration in Step S28, the shared content managing information 350 is saved (Step S30).

On the other hand, when it is judged that the currently uploaded shared content managing information 350 has a timestamp older than that of the previously uploaded shared content managing information 350, the restoration storage controller 412 performs the process in Step S22.

When it is judged that the uploaded data is not the shared content managing information 350 in Step S27, the restoration storage controller 412 judges whether or not the uploaded data is an upload request of the content data 340 according to the process in the above-described Step S13 (Step S31). In Step S31, when it is judged that the uploaded data is not the upload request of the content data 340, the restoration storage controller 412 performs an upload receipt process (Step S33), recognizing that the uploaded data is an upload request of the reproduction schedule data 341 according to the process in the above-described Step S7 (Step S32). Then, the restoration storage controller 412 makes the terminal folder 332 for the terminal 50 from which the reproduction schedule data 341 is uploaded in the server storage 33 and stores the reproduction schedule data 341 in the terminal folder 332 (Step S34).

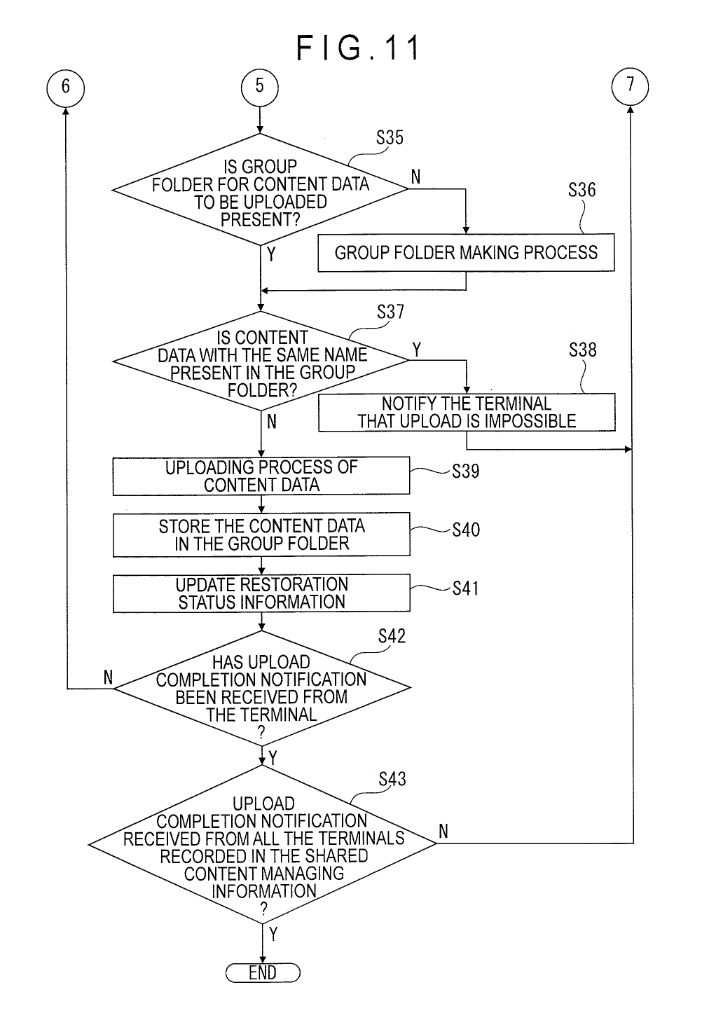

On the other hand, when the restoration storage controller 412 judges that the uploaded data is the upload request of the content data 340 in Step S31, the restoration storage controller 412 judges whether or not the group folder 330 corresponding to the content data 340 is present in the server storage 33 as shown in FIG. 11 (Step S35) and make the group folder 330 when it is judged that the group folder 330 is not present (Step S36). When it is judged that the group folder 330 is present after Step S36 or in Step S35, the restoration storage controller 412 judges whether or not the content data 340 with the same name is present in the group folder 330 (Step S37).

In Step S37, when it is judged that the content data 340 with the same name is present, the restoration storage controller 412 notifies to the terminal 50 that the content data 340 cannot be uploaded (Step S38) and performs the process in Step S22. In Step S37, when the restoration storage controller 412 judges that the content data 340 with the same name is not present, the restoration storage controller 412 uploads the content data 340 (Step S39) and stores the content data 340 in the group folder 330 (Step S40).

Then, the server restoration status management unit 411 records and updates the information relating to the content data 340 stored in Step S40 in the restoration management information (Step S41). Subsequently, the restoration storage controller 412 judges whether or not the upload completion notification is received from the terminal 50 according to the above-described process in Step S11 (Step S42). When it is judged that the upload completion notification is not received in Step S42, the restoration storage controller 412 performs the process in Step S31 recognizing that the data is to be further uploaded from the terminal 50 from which the content data 340 is uploaded. When it is judged that the upload completion notification is received in Step S42, the restoration storage controller 412 judges whether the upload completion notification is received from all of the terminals recorded in the shared content managing information 350, recognizing that the data is not to be further uploaded from the terminal 50 from which the content data 340 is uploaded (Step S43). Then, when it is determined that the upload completion notification is not received in Step S43, the restoration procedure controller 672 performs the process in Step S22. When it is determined that the upload completion notification is received in Step S43, the restoration procedure controller 672 terminates the restoration process.

### Advantages of First Exemplary Embodiment

According to the above-described first exemplary embodiment, the following advantages can be obtained.

(1) The server 30 of the advertisement distribution system 1 allows downloading of the content data 340 in response to the request of the terminal 50 and makes the terminal 50 periodically download the shared content managing information 350. Then, when the server 30 recognizes that the content data 340 stored in the server storage 33 before the server storage goes out of order has to be stored in a new server storage 33 (restoration process), the server 30 makes the terminal 50 upload the shared content managing information 350 and acquires from the terminal 50 the content data 340 specified by the content name information 353 of the shared content managing information 350 to store the content data 340 in the new server storage 33.

Thus, since the content data 340 to be reproduced in, for instance, the group A is distributed to the first to third terminals 51 to 53 without dividing, it is not necessary to divide the content data 340 as in a typical arrangement. Further, when, for instance, the first terminal 51 goes out of order, all of the content data 340 of the group A can be acquired from the second and third terminals 52 and 53 and the server 30 can store the content data 340 in the new server storage 33. In addition, since the server 30 acquires the content data 340 based on the shared content managing information 350 reflecting the storing status in the server storage 33, old content data 340 not necessary for the restoration process is not uploaded. Thus, the server storage 33 can be appropriately restored with a simple control.

(2) The server 30 sends the restoration status information for specifying the content data 340 stored in the server storage 33 by the restoration process to the terminal 50. Then, the terminal 50 uploads to the server 30 the content data 340 stored in the terminal storage 63 but not recorded in the restoration status information.

Accordingly, when, for instance, the first terminal 51 stores all the content data 340 for the group A, all of the content data 340 for the group A can be acquired only from the first terminal 51, so that the server storage 33 can be efficiently restored.

(3) The server 30 distributes to all of the terminals 50 the shared content managing information 350 recorded with the name of all of the content data 340 stored in the server storage 33 and distribution destination of the content data 340.

Thus, when the shared content managing information 350 stored in all of the terminals 50 belonging to, for instance, the group A (i.e. the first to third terminals 51 to 53) is destroyed, the server 30 can acquire all the content data 340 for the group A from one of the first to third terminals 51 to 53 based on the shared content managing information 350 from, for instance, the fourth terminal 54 belonging to the group B.

(4) The server storage 33 is restored in an arrangement in which the server 30 distributes the content data 340 to the terminal 50.

Thus, since the restoration can be appropriately performed in the distribution system of the content data 340 that is used by many users, the content data 340 can be viewed and/or listened without impairing the convenience of the user.

(5) The server storage 33 is restored in an arrangement in which the reproduction schedule data 341 of the content data 340 is distributed from server 30 to the terminal 50.

Thus, when there is a trouble in the server storage, the reproduction state of the content data 340 before the trouble can be rapidly recovered.

### Second Exemplary Embodiment

Next, a second exemplary embodiment of the invention will be described below. It should be understood that the same components and functions as those in the first exemplary embodiment will be denoted by the same reference numerals and explanations thereof will be omitted as necessary. Further, the components performing processes similar to those in the first exemplary embodiment will be denoted by the same reference numerals and explanations thereof will be simplified.

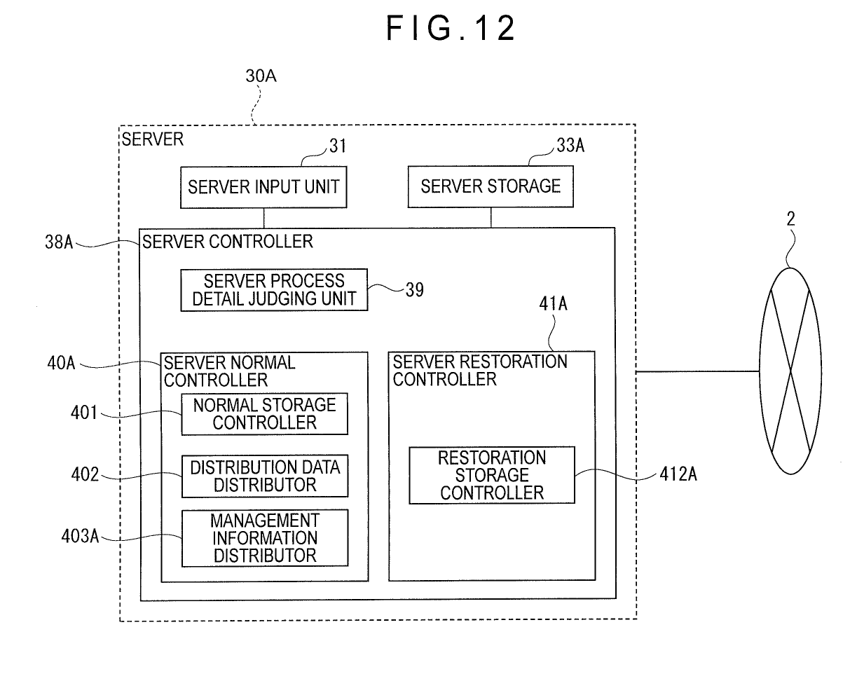

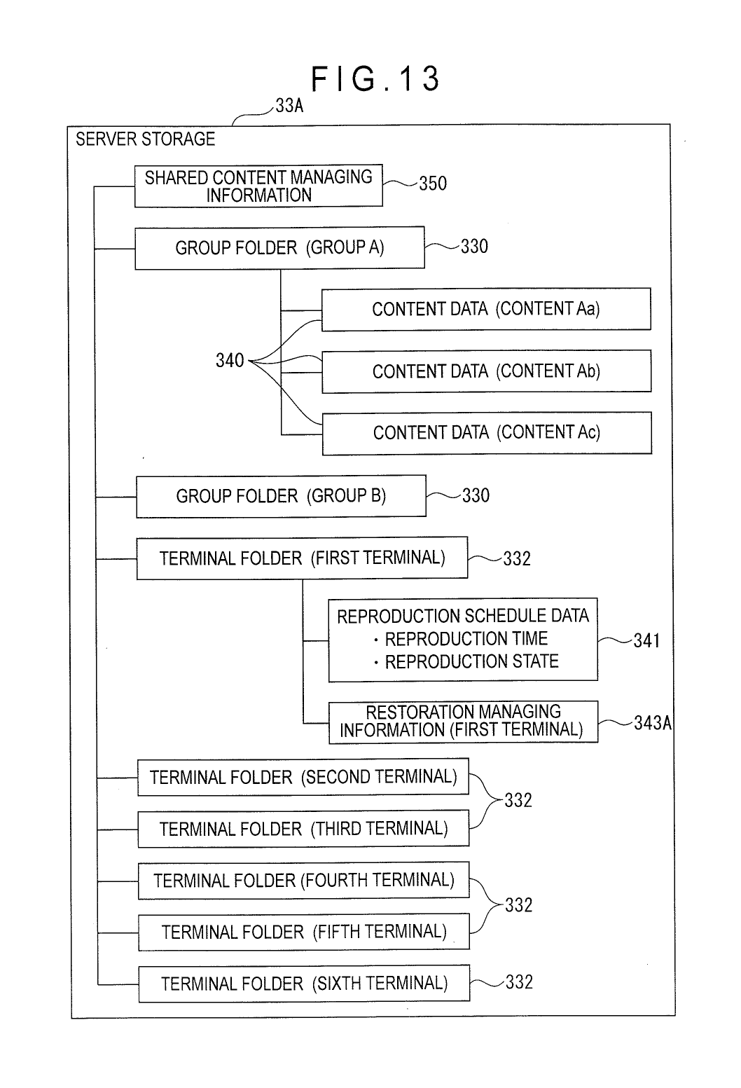

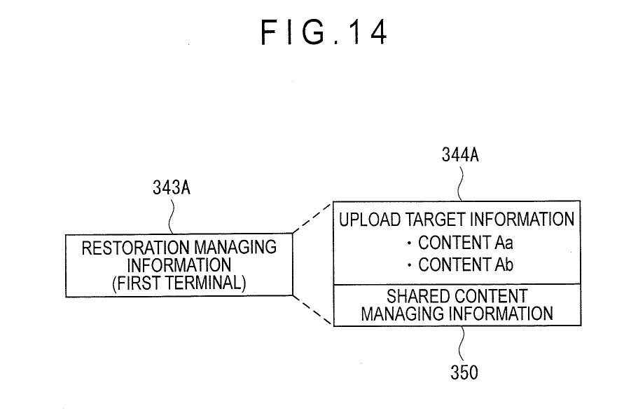

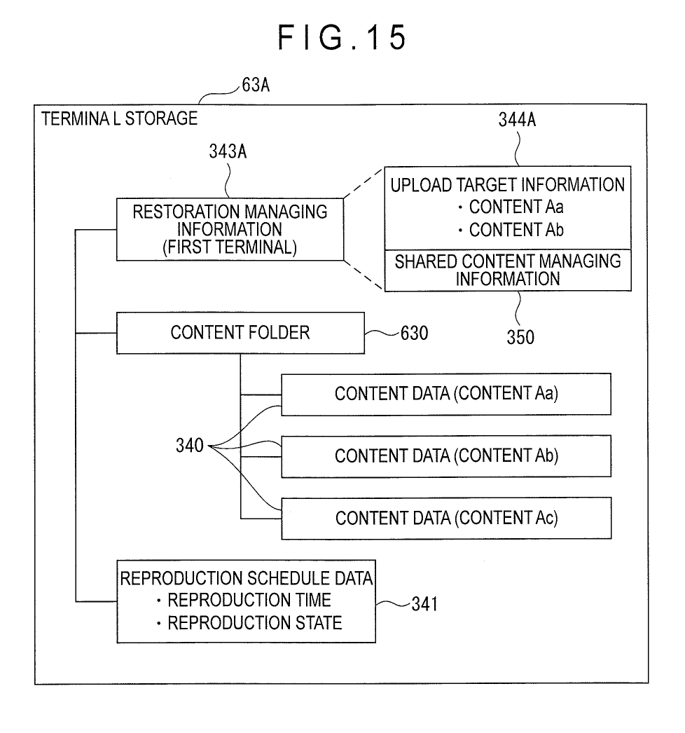

FIG. 12 is a block diagram of the server. FIG. 13 schematically shows a storing status of the server storage. FIG. 14 schematically shows a construction of restoration managing information. FIG. 15 schematically shows a storing status of a terminal storage.

Arrangement of Advertisement Distribution System

Initially, an arrangement of the advertisement distribution system will be described below.

As shown in FIG. 1, an advertisement distribution system 1A (data processing system) includes a network 2, a server 30A (data distribution device) and first to sixth terminals (data processing device) 51A to 56A.

Incidentally, when the first to sixth terminals 51A to 56A are collectively referred to, they are represented as a terminal 50A.

As shown in FIG. 12, the server 30 (e.g. a computer) includes a server storage 33A and a server controller 38A serving as a distributor storage and a restoration target storage in place of the server storage 33 and the server controller 38 of the server 30 according to the first exemplary embodiment.

As shown in FIG. 13, the server storage 33A stores the shared content managing information 350, the group folder 330 that is adapted to store the content data 340 and the terminal folder 332. Further, the reproduction schedule data 341 and restoration managing information 343A are stored in the terminal folders 332 each corresponding to the first to sixth terminals 51A to 56A. As shown in FIGS. 14 to 16, the restoration managing information 343A includes upload target information 344A (transmission target information) and the shared content managing information 350. The name of the content data 340 to be uploaded to the server 30A among the content data 340 that has been downloaded by the first to sixth terminals 51A to 56A is recorded in the upload target information 344A. For instance, the upload target information 344A corresponding to the first terminal 51A is recorded with the name of the contents Aa and Ab as shown in FIG. 14. Further, the names of the contents as listed in the following Table 1 are recorded in the upload target information 344A corresponding to the second to sixth terminals 52A to 56A.

TABLE 1

| | | Name of Content Recorded |
|---|---|---|
| | Belonging | in the Upload Target |
| | Group | Information |
| First Terminal | A | Contents Aa, Ab |
| Second Terminal | A | Contents Ab, Ac |
| Third Terminal | A, B | Contents Aa, Ac, Ba |
| Fourth Terminal | B | Contents Ba |
| Fifth Terminal | B | Contents Bb |
| Sixth Terminal | B | Contents Ba |

In other words, the name of the contents corresponding to the group to which the first to sixth terminals 51A to 56A belong is recorded in the upload target information 344A. Further, the upload target information 344A is configured so that each of the contents is uploadable from two terminals among the first to sixth terminals 51A to 56A.

The server controller 38A is provided by various programs including a server normal controller 40A and a server restoration controller 41A in place of the server normal controller 40 and the server restoration controller 41 of the server controller 38 according to the first exemplary embodiment, as shown in FIG. 12.

Further, the server normal controller 40A is provided with a management information distributor 403A (transmission target information sending unit) in place of the management information distributor 403 of the server normal controller 40 in the first exemplary embodiment.

The management information distributor 403A generates the shared content managing information 350 and stores the shared content managing information 350 in the server storage 33A. Further, the management information distributor 403A generates the restoration managing information 343A and stores the restoration managing information 343A in the terminal folder 332 of the server storage 33A Specifically, the management information distributor 403A generates the shared content managing information 350 reflecting a storing status in the server storage 33A and stores the shared content managing information 350 in the server storage 33A. Further, when the restoration managing information 343A of the first terminal 51A belonging to the group A is generated, the management information distributor 403A generates the upload target information 344A recorded with the name of the contents Aa and Ab and combines the upload target information 344A with the shared content managing information 350. Then, the management information distributor 403A stores the restoration managing information 343A in the terminal folder 332 of the first terminal 51A.

Further, the management information distributor 403A updates the shared content managing information 350 and the restoration managing information 343A reflecting the storing status in the server storage 33A. In addition, the management information distributor 403A makes the each of the terminals to periodically download the restoration managing information 343A stored in the corresponding terminal folders 332. In other words, the management information distributor 403A makes the first to sixth terminals 51A to 56A download the restoration managing information 343A with different contents.

The server restoration controller 41A includes only a restoration storage controller 412A (storage controller) serving also as a distribution-side management information acquirer.

When the content data 340 or the reproduction schedule data 341 is uploaded from the terminal 50A, the restoration storage controller 412A generates the group folder 330 and the terminal folder 332 as necessary to store the content data 340 and the reproduction schedule data 341 therein.

Further, when the restoration managing information 343A is uploaded for the first time from the terminal 50A, the restoration storage controller 412A deletes the upload target information 344A from the restoration managing information 343A and stores only the shared content managing information 350 in the server storage 33A. Further, when the restoration managing information 343A is uploaded while the shared content managing information 350 is stored in the server storage 33A, newer (i.e. with an earlier timestamp) one of the shared content managing information 350 of the restoration managing information 343A and the previously stored shared content managing information 350 is stored in the server storage 33A.

As shown in FIG. 5, the first terminal 51A (e.g. a computer) includes a terminal storage 63A (a processing-side storage) and a terminal controller 64A in place of the terminal storage 63 and the terminal controller 64 of the first terminal 51 according to the first exemplary embodiment. It should be noted that the first to sixth terminals 51A to 56A have the same arrangement.

As shown in FIG. 15, the terminal storage 63A stores the content data 340 stored in the content folder 630, the restoration managing information 343A corresponding to the first terminal 51A and the reproduction schedule data 341.

The terminal controller 64A is provided by various programs including a terminal normal controller 66A and a terminal restoration controller 67A in place of the terminal normal controller 66 and the terminal restoration controller 67 of the terminal controller 64 according to the first exemplary embodiment, as shown in FIG. 5.

Further, the server normal controller 66A is provided with a management information accumulating unit 662A (processing-side management information acquirer) in place of the management information distributor 662 of the terminal normal controller 66 in the first exemplary embodiment.

The management information accumulating unit 662A periodically downloads the restoration managing information 343A from the server 30A and stores the restoration managing information 343A in the terminal storage 63A.

The terminal restoration controller 67 includes a terminal restoration status management unit 671A and a restoration procedure controller 672A (a distribution data returning unit).

When a restoration request is returned from the server 30A, the terminal restoration status management unit 671A selects from the content data 340 stored in the terminal storage 63A the content data 340 recorded in the upload target information 344A of the restoration managing information 343A as the upload target data. For instance, the terminal restoration status management unit 671A of the first terminal 51A selects the content data 340 for the contents Aa and Ab from the contents Aa, Ab and Ac stored in the terminal storage 63A as the upload target data as shown in FIG. 14.

The restoration procedure controller 672A uploads the content data selected as the upload target data by the terminal restoration status management unit 671A to the server 30A, and, when the reproduction schedule data 341 and the restoration managing information 343A are not uploaded to the server 30A, uploads the reproduction schedule data 341 and the restoration managing information 343A to the server 30A.

Operation of Advertisement Distribution System

Next, an operation of the advertisement distribution system will be described below.

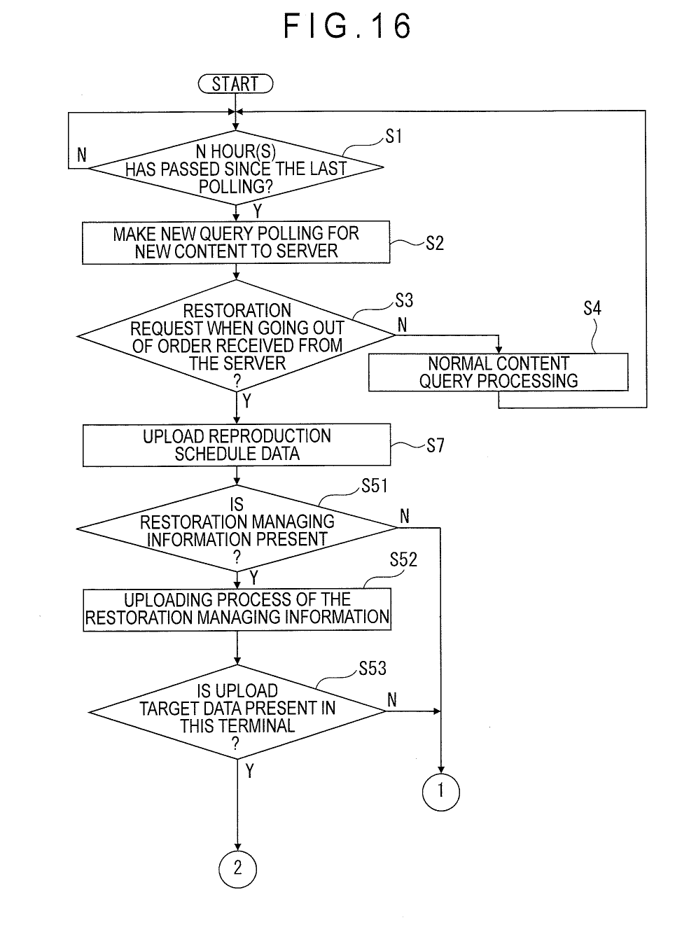

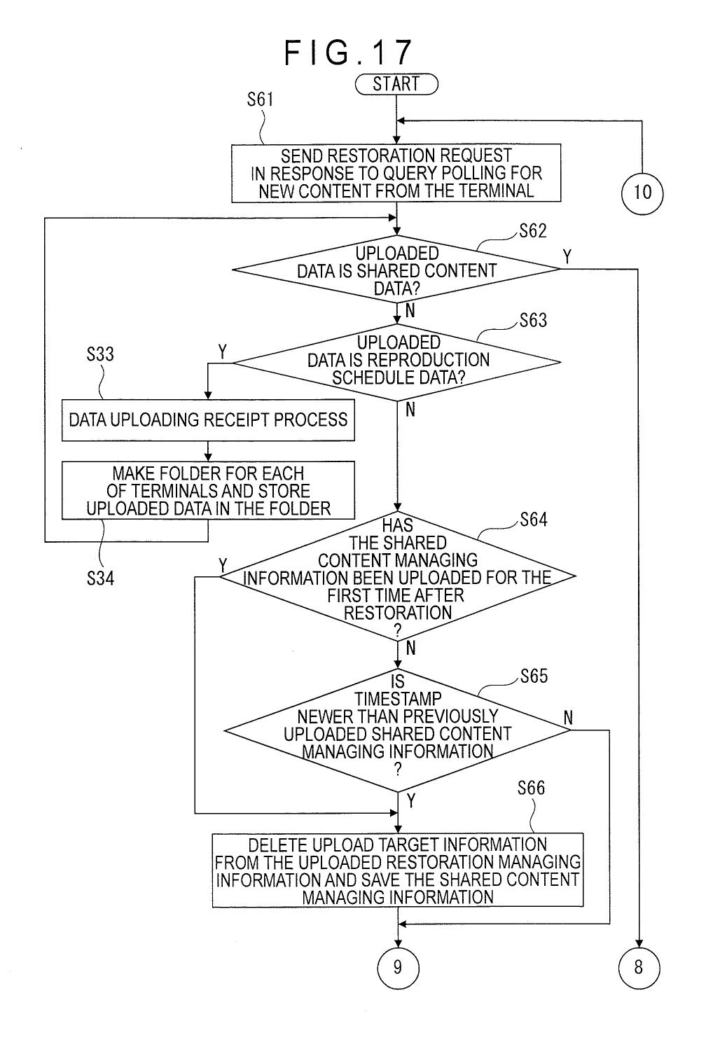

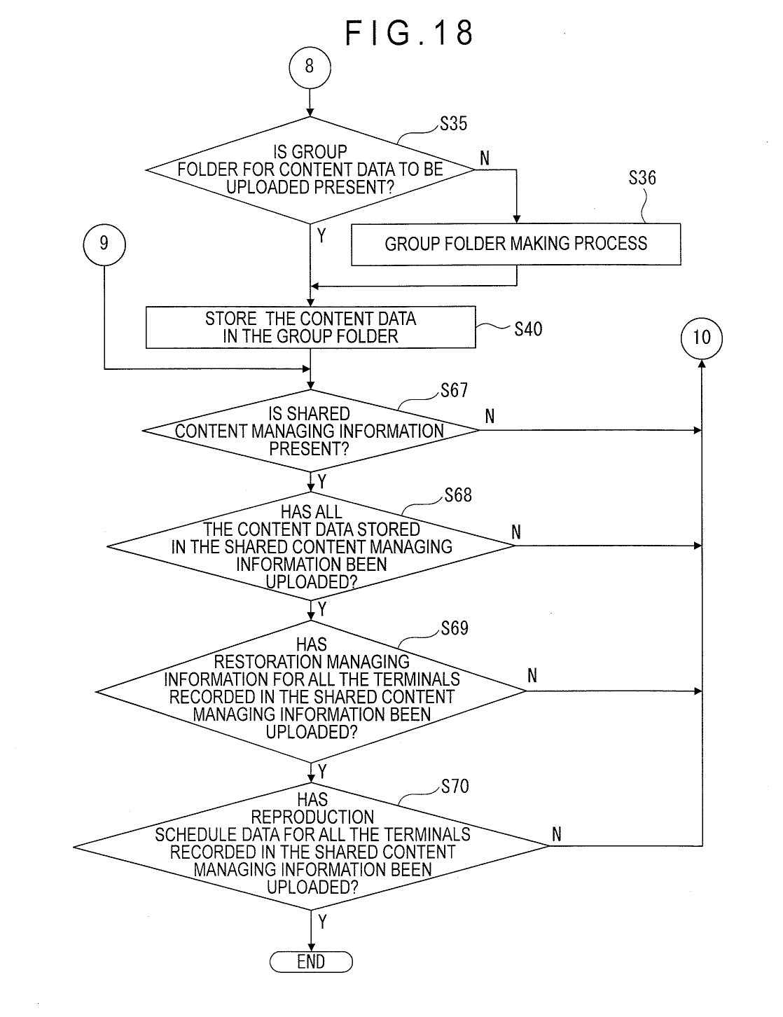

FIG. 16 is a flowchart showing the operation of the terminal in the restoration process. FIGS. 17 and 18 are flowcharts showing the operation of the server in the restoration process.

As shown in FIG. 16, the terminal controller 64A of the first terminal 51A performs the processes of Steps S1 to S4. Then, when it is determined that the restoration request is returned in Step S3, the terminal controller 64A performs the process in Step S7 by the restoration procedure controller 672A and judges whether or not the restoration managing information 343A is present in the terminal storage 63A (Step S51). When it is determined in Step S51 that the restoration managing information 343A is not present, the restoration procedure controller 672A performs the process in Step S11, i.e. sends the upload completion notification. When it is determined in Step S51 that the restoration managing information 343A is present, the restoration procedure controller 672A uploads the restoration managing information 343A (Step S52).

Subsequently, the terminal restoration status management unit 671A judges whether the content data 340 (i.e. upload target data) of which name is recorded in the upload target information 344A is present in the terminal storage 63A (Step S53). In Step S53, when it is judged that such content data 340 is present, the terminal restoration status management unit 671A performs the processes in Steps S12 to S17 shown in FIG. 8 and uploads the content data as necessary. On the other hand, when it is judged that such content data 340 is not present in Step S53, the terminal restoration status management unit 671A performs the processes in Step S11 shown in FIG. 8.

On the other hand, when the server controller 38A of the server 30A recognizes the restoration state and receives the query polling for new content according to the above-described process in Step S2 from the terminal 50A, the server controller 38A returns a restoration request to the terminal 50A (Step S61) as shown in FIG. 17. Subsequently, the restoration storage controller 412A judges whether or not the data for which upload is requested from the terminal 50 is the content data 340 according to the above-described process in Step S13 (Step S62). In Step S62, when it is judged that the data is the content data 340, the restoration storage controller 412A performs the processes in Steps S35, 36 and S40 and stores the content data 340 in the server storage 33A as shown in FIG. 18.

When the restoration storage controller 412A judges that data is not the content data 340 in Step S62, the restoration storage controller 412 judges whether or not the data is the reproduction schedule data 341 according to the process in Step S7 (Step S63). Then, when it is determined in Step S63 that the data is the reproduction schedule data 341, the restoration storage controller 412A performs the processes in Steps S33 and S34 to store the reproduction schedule data 341 in the server storage 33A and, subsequently, performs the process in Step S62. On the other hand, when it is judged in Step S63 that the data is the restoration managing information 343A according to the process in the above-described Step S52, the restoration storage controller 412A judges whether or not the restoration managing information 343A is uploaded for the first time after the restoration (Step S64). When it is judged in Step S64 that the restoration managing information 343A is not uploaded for the first time after the restoration, the restoration storage controller 412A judges whether or not the timestamp of the shared content managing information 350 of the restoration managing information 343A is earlier than the shared content managing information 350 of the restoration managing information 343A (Step S65). When it is judged that the timestamp is earlier in Step S65, the restoration storage controller 412A deletes the upload target information 344A from the currently uploaded restoration managing information 343A and stores the shared content managing information 350 in the server storage 33A (Step S66). When it is judged that the restoration managing information 343A is uploaded for the first time after restoration in Step S64, the restoration storage controller 412A performs the process in Step S66.

When restoration storage controller 412A judges in Step S65 that the timestamp of the currently uploaded restoration managing information 343A is older or when the restoration storage controller 412A performs the process in Step S66, the restoration storage controller 412A judges whether or not the shared content managing information 350 is present in the server storage 33A as shown in FIG. 18 (Step S67). When the restoration storage controller 412A judges in Step S67 that the shared content managing information 350 is not present, the restoration procedure controller 412A performs the process in Step S61 shown in FIG. 17. When the restoration storage controller 412A judges in Step S67 that the shared content managing information 350 is present, the restoration storage controller 412A judges whether all the content data 340 recorded in the shared content managing information 350 has been uploaded or not (Step S68).

When the restoration storage controller 412A judges in Step S68 that all the content data 340 has not been uploaded, the restoration procedure controller 412A performs the process in Step S61. When the restoration storage controller 412A judges in Step S67 that all the content data 340 has been uploaded, the restoration storage controller 412A judges whether the restoration managing information 343A of all of the terminals 50A recorded in the shared content managing information 350 has been uploaded or not (Step S69). When the restoration storage controller 412A judges in Step S69 that the restoration managing information 343A has not been uploaded, the restoration procedure controller 412A performs the process in Step S61. When the restoration storage controller 412A judges that the restoration managing information 343A has been uploaded, the restoration storage controller 412A judges whether the reproduction schedule data 341 of all of the terminals 50A recorded in the shared content managing information 350 has been uploaded or not (Step S70).

Then, when it is determined that the reproduction schedule data 341 has not been uploaded in Step S70, the restoration storage controller 412A performs the process in Step S61. When it is determined that the reproduction schedule data 341 has been uploaded in Step S70, the restoration storage controller 412A terminates the restoration process.

### Advantages of Second Exemplary Embodiment

According to the above-described second exemplary embodiment, the following advantages as well as the advantages (1) and (3) to (5) in the first exemplary embodiment can be obtained.

(6) The server 30A generates the upload target information 344A for specifying the content data 340 to be uploaded to the server 30A during restoration and makes the terminal 50A download the upload target information 344A. Then, when the terminal 50A receives the restoration request, the terminal 50A uploads the content data 340 specified by the upload target information 344A to the server 30A.

Thus, the server 30A can upload the content data 340 in parallel while efficiently using the bandwidth of each of the terminals 50A. Further, since the server 30A generates the upload target information 344A and make the terminal 50A download the upload target information 344A before a trouble occurs, the process after the trouble occurs can be simplified and the restoration process can be rapidly conducted.

(7) The server 30A sends the upload target information 344A that requests the transmission of two of the three content data 340 for the group A and differs in the details of the request to the first to third terminals 51A to 53A of the group A.

Accordingly, while, for instance, the first terminal 51A is uploading the content data 340 of the contents Aa and Ab for the group A, the content data 340 of the content Ac not to be uploaded by the first terminal 51A can be uploaded by the second terminal 52A, so that the efficiency of the restoration process can be enhanced. Further, since it is only necessary for the first to third terminals 51A to 53A to upload at most two content data 340, the processing load on the first to third terminals 51A to 53A can be restrained to the minimum.

### Third Exemplary Embodiment

Next, a third exemplary embodiment of the invention will be described below. It should be understood that the same components and functions as those in the first and second exemplary embodiments will be denoted by the same reference numerals and explanations thereof will be omitted as necessary. Further, the components performing processes similar to those in the first exemplary embodiment will be denoted by the same reference numerals and explanations thereof will be simplified.

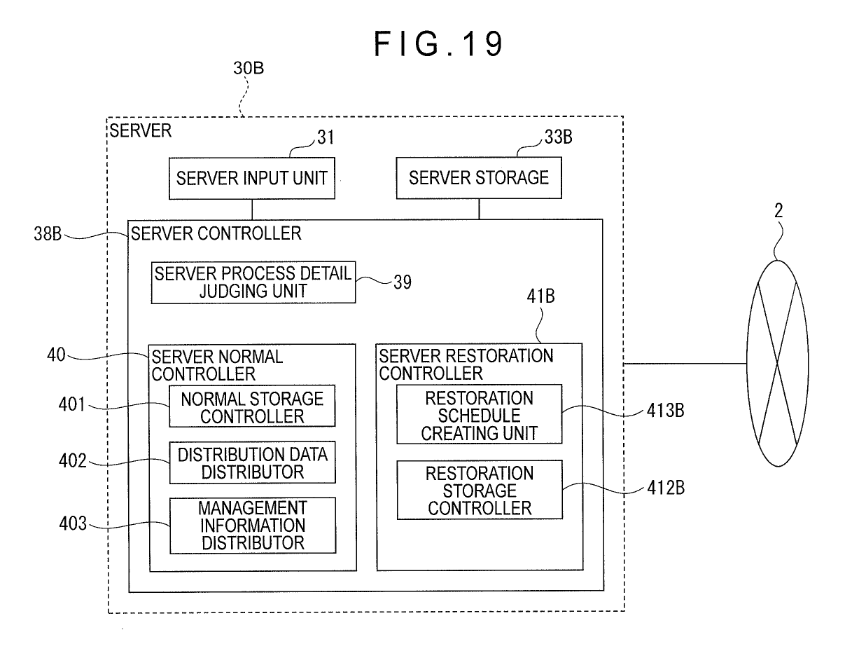

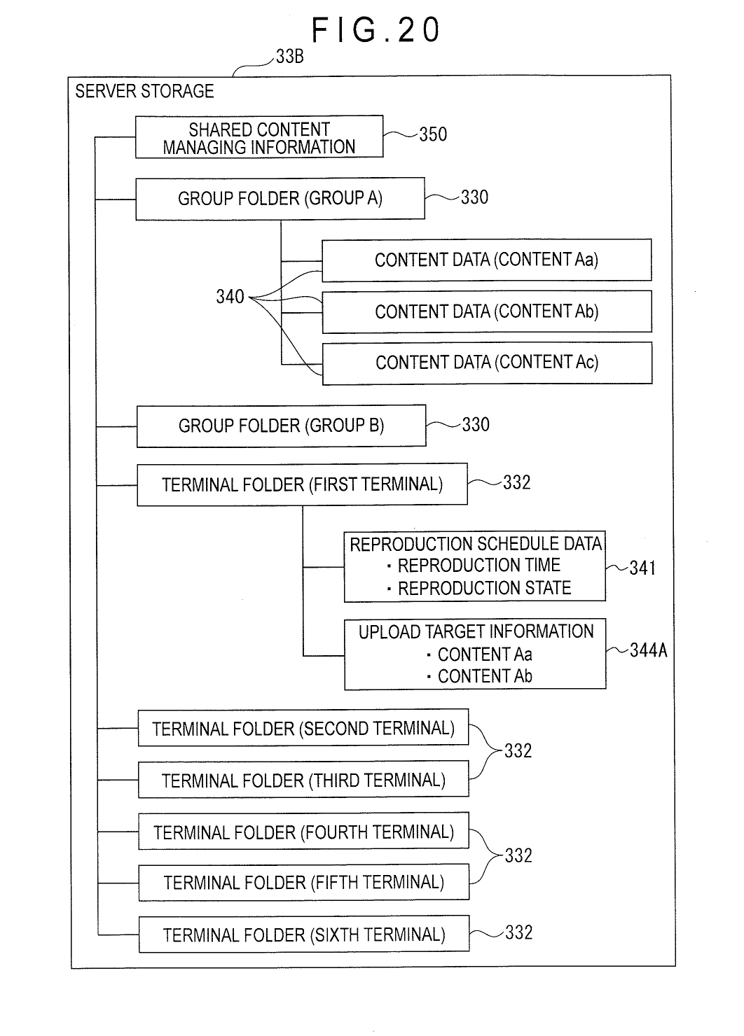

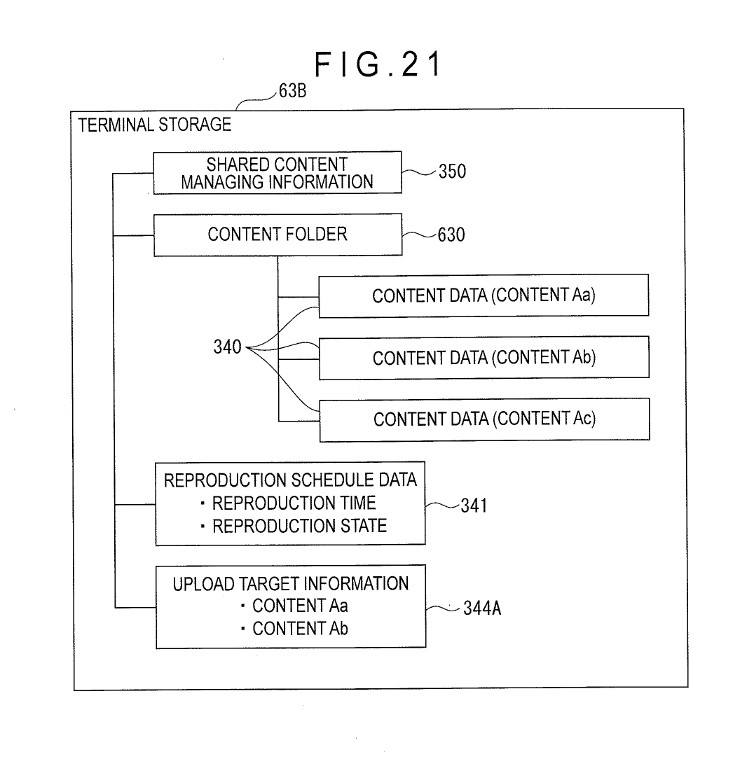

FIG. 19 is a block diagram of the server. FIG. 20 schematically shows a storing status of the server storage. FIG. 21 schematically shows a storing status of the terminal storage.

Arrangement of Advertisement Distribution System

Initially, an arrangement of the advertisement distribution system will be described below.

As shown in FIG. 1, an advertisement distribution system 1B (data processing system) includes a network 2, a server 30B (data distribution device) and first to sixth terminals (data processing devices) 51B to 56B. Incidentally, when the first to sixth terminals 51B to 56B are collectively referred to, they are called as a terminal 50B.

As shown in FIG. 19, the server 30B (e.g. a computer) includes a server storage 33B and a server controller 38B serving as a distributor storage and a restoration target storage in place of the server controller 33 and the server controller 38 of the server 30 according to the first exemplary embodiment.

As shown in FIG. 20, the server storage 33B stores the shared content managing information 350, the group folder 330 that is adapted to store the content data 340 and the terminal folder 332. Further, the reproduction schedule data 341 and upload target information 344A are stored in the terminal folders 332 each corresponding to the first to sixth terminals 51B to 56B. The upload target information 344A corresponding to the first to sixth terminals 51B to 56B is the same as the upload target information 344A in the second exemplary embodiment. As shown in the above Table 1, among the content data 340 having been downloaded by the first to sixth terminals 51B to 56B, the name of the content data 340 to be uploaded to the server 30B is recorded in the upload target information 344A.

The server controller 38B is provided by various programs including a server restoration controller 41B in place of the server restoration controller 41 of the server controller 38 according to the first exemplary embodiment, as shown in FIG. 19.

The server restoration controller 41B includes a restoration schedule creating unit 413B (transmission target information sending unit) and a restoration storage controller 412B (storage controller) serving also as distribution-side management information acquirer.

When the shared content managing information 350 is uploaded for the first time from the terminal 50B during the restoration status, the restoration schedule creating unit 413B stores the shared content managing information 350 in the server storage 33B as content-upload management data. Then, based on the content name information 353 and the terminal list information 354 in the content-upload management data, the restoration schedule creating unit 413B recognizes the number of contents to be reproduced by each of the groups and the number of terminals 50B belonging to each of the groups, and generates the upload target information 344A, which is stored in the server storage 33B. In other words, the restoration schedule creating unit 413B performs the generating process of the upload target information 344A as the upload schedule generating process of the content data 340.

When the content data 340 or the reproduction schedule data 341 is uploaded from the terminal 50B, the restoration storage controller 412B generates the group folder 330 and the terminal folder 332 as necessary to store the content data 340 and the reproduction schedule data 341 therein.

Further, the restoration storage controller 412B makes the terminal 50B download the upload target information 344A.

As shown in FIG. 5, the first terminal 51B (e.g. a computer) includes a terminal storage 63B serving as a processing-side storage and a terminal controller 64B in place of the terminal storage 63 and the terminal controller 64 of the first terminal 51 according to the first exemplary embodiment. It should be noted that the first to sixth terminals 51B to 56B have the same arrangement.

As shown in FIG. 21, the terminal storage 63B stores the shared content managing information 350, the content data 340 stored in the content folder 630, the reproduction schedule data 341 and the upload target information 344A corresponding to the first terminal 51B.

The terminal controller 64B is provided by various programs including a terminal restoration controller 67B in place of the terminal restoration controller 67 of the terminal controller 64 according to the first exemplary embodiment, as shown in FIG. 5. Further, the server normal controller 67B is provided with a terminal restoration status management unit 671B in place of the terminal restoration status management unit 671A in the second exemplary embodiment.

When the upload target information 344A is downloaded from the server 30B, the terminal restoration status management unit 671B selects from the content data 340 stored in the terminal storage 63B the content data 340 recorded in the upload target information 344A as the upload target data.

Operation of Advertisement Distribution System

Next, an operation of the advertisement distribution system will be described below.

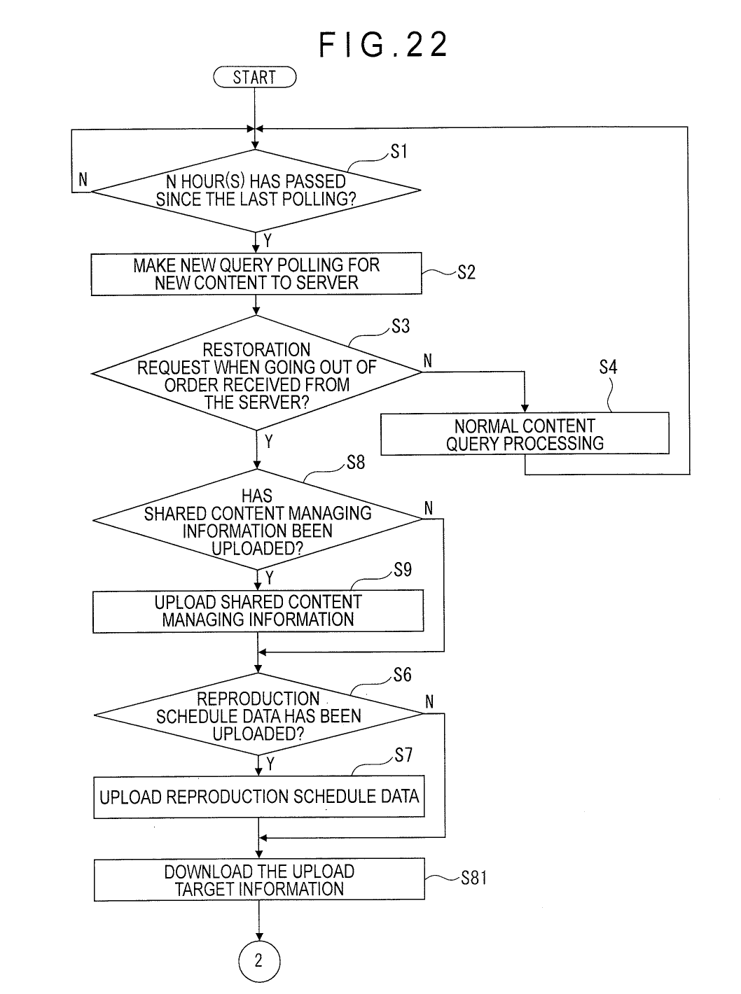

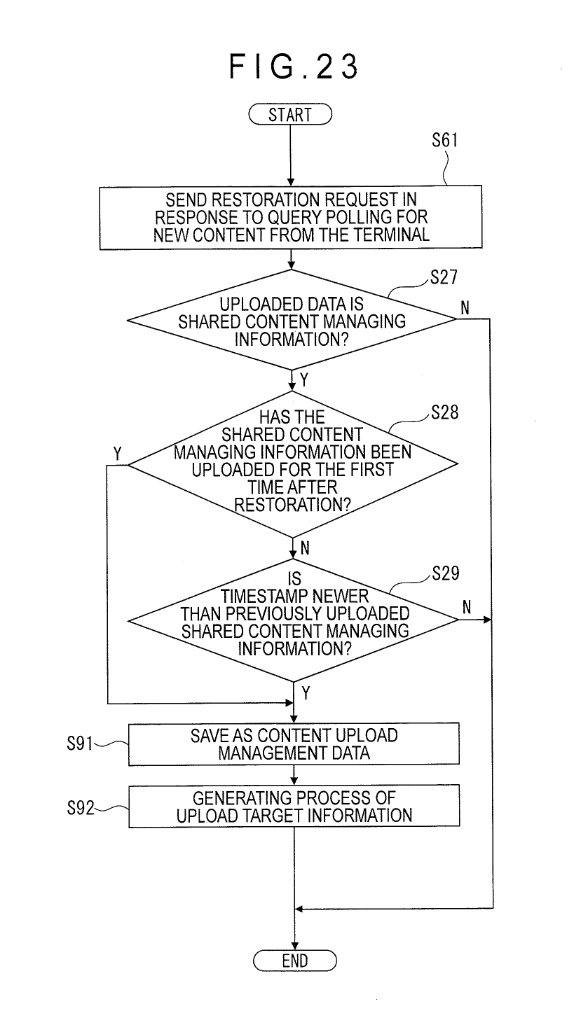

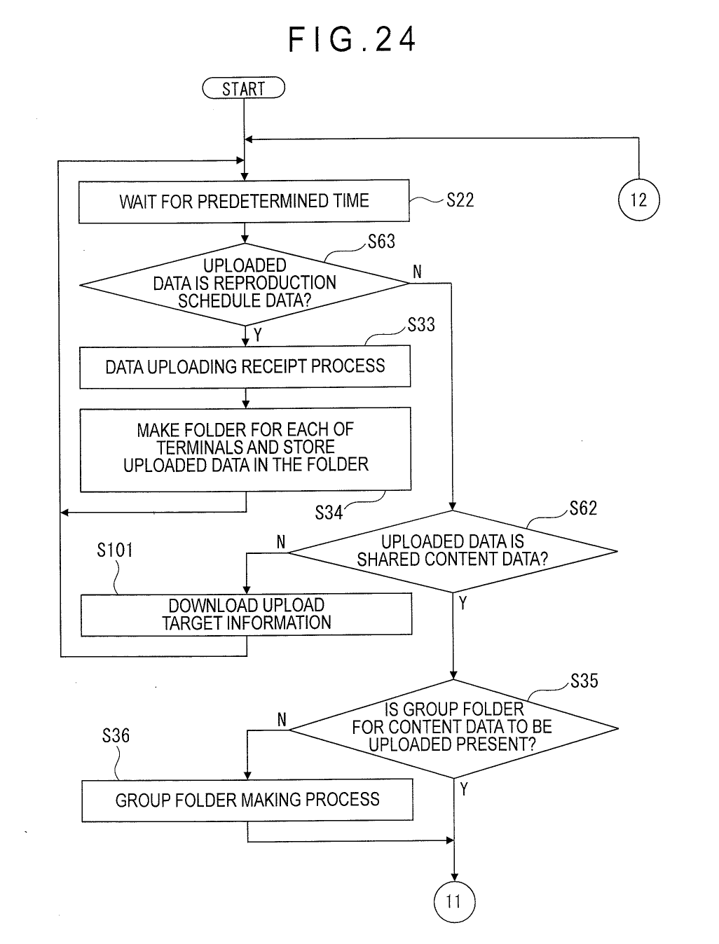

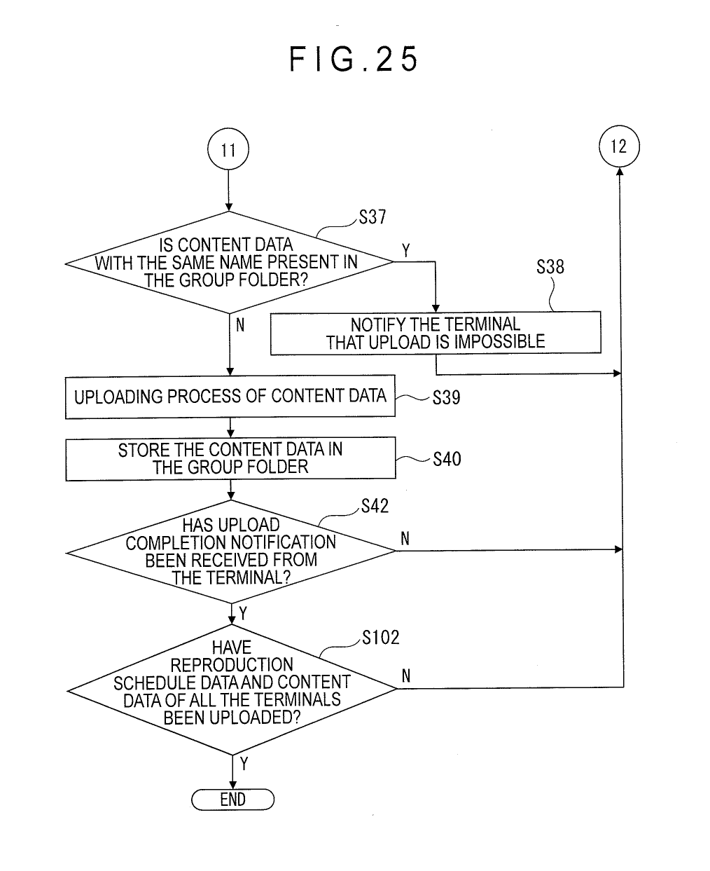

FIG. 22 is a flowchart showing the operation of the terminal in the restoration process. FIG. 23 is a flowchart showing an operation of the server for generating the upload target information. FIGS. 24 and 25 are flowcharts showing the operation of the server in the restoration process.

As shown in FIG. 22, the terminal controller 64B of the first terminal 51B performs the processes of Steps S1 to S4 and, when it is determined that a restoration request is returned in Step S3, the restoration procedure controller 672A performs the processes in Steps S8, S9, S6 and S7. Further, the terminal restoration status management unit 671B downloads the upload target information 344A from the server 30B (Step S81) and performs the processes in Steps S12 to S17 shown in FIG. 8. According to the processes in Steps S12 to S17, the content data 340 specified by the upload target information 344A is uploaded to the server 30B as the upload target data.

On the other hand, as shown in FIG. 23, the server controller 38B of the server 30B performs the processes of Steps S61 and S27 to S29 in the generating process of the upload target information 344A. When it is judged that the upload data is not the shared content managing information 350 in Step S27 or when it is judged that the timestamp of the currently uploaded shared content managing information 350 is older than that of the previously uploaded shared content managing information 350 in Step S29, the restoration schedule creating unit 413B terminates the generating process of the upload target information 344A.

Further, when it is judged that the shared content managing information 350 is uploaded for the first time after restoration in Step S28 or when it is judged that the timestamp of the currently uploaded shared content managing information 350 is earlier than that of the previously uploaded shared content managing information 350 in Step S29, the restoration schedule creating unit 413B stores the current shared content managing information 350 as the content-upload management data (Step S91). Subsequently, the restoration schedule creating unit 413B generates the upload target information 344A for distribution to each of the first to the sixth terminals 51B to 56B based on the content-upload management data, and stores the upload target information 344A in the server storage 33B (Step S92).

Further, as shown in FIG. 24, the server controller 38B of the server 30B performs the processes of Steps S22, S63, S33 and S34 in the restoration process of the server storage 33B. When the restoration storage controller 412B judges that the upload request data is not the reproduction schedule data 341 according to the process in the above-described Step S7, the restoration storage controller 412B judges whether or not the data of which download is requested is the content data 340 according to the above-described process in Step S13 (Step S62). Then, in Step S62, when it is judged that the data is the content data 340, the restoration storage controller 412B performs the processes in Steps S35 to S40 and stores the content data 340 in the server storage 33B as shown in FIG. 24 and FIG. 25.

On the other hand, when it is judged in Step S62 that the data is not the content data 340, the restoration storage controller 412B makes the terminal 50B from which the upload is requested download the upload target information 344A (Step S101) and performs the process in Step S22.

When the restoration storage controller 412B performs the process in Step S42 after the process in Step S40 and judges that the restoration storage controller 412B has not received the upload completion notification from the terminal 50B, the restoration storage controller 412B performs the process in Step S22. On the other hand, when it is judged that the restoration storage controller 412B has received the upload completion notification, the restoration storage controller 412B judges whether or not the content data 340 and the reproduction schedule data 341 of all the terminals 50B have been uploaded (Step S102).

Then, when it is determined that the content data 340 and the reproduction schedule data 341 of all the terminals 50B have not been uploaded in Step S102, the restoration storage controller 412B performs the process in Step S22. When it is determined that the content data 340 and the reproduction schedule data 341 of all the terminals 50B have been uploaded in Step S102, the restoration storage controller 412B terminates the restoration process.

### Advantages of Third Exemplary Embodiment

According to the above-described third exemplary embodiment, the following advantages as well as the advantages (1) and (3) to (5) in the first exemplary embodiment and the advantage (7) in the second exemplary embodiment can be obtained.

(8) The server 30B makes the terminal 50B upload the shared content managing information 350 during the restoration after a trouble occurs. Then, the server 30B makes the terminal 50B download the upload target information 344A generated based on the shared content managing information 350 and makes the terminal 50B upload the content data 340 specified by the target information 344A to the server 30B.

Thus, the server 30B can upload the content data 340 in parallel while efficiently using the bandwidth of each of the terminals 50B. Further, it is not necessary for the server 30B to generate the upload target information 344A before a trouble occurs, so that processing load can be reduced.

### Other Exemplary Embodiment

It should be understood that the scope of the invention is not limited to the above-described exemplary embodiments but includes modifications and improvements as long as an object of the invention can be achieved.

Specifically, though the shared content managing information 350 having the group managing information 351 of the groups A and B is sent to all the terminals 50, 50A and 50B in the first to third exemplary embodiments, the group managing information 351 of the group A may be sent only to the first to third terminals 51 to 53, 51A to 53A and 51B to 53B belonging to the group A and the group managing information 351 of the group B may be sent only to the first to third terminals 53 to 56, 53A to 56A and 53B to 56B belonging to the group B.

Further, in the third exemplary embodiment, without making the terminal 50B download the upload target information 344A in the restoration process, the content data 340 necessary for the restoration may be requested to the terminal 50B and make the terminal 50B upload the necessary content data 340 based on the shared content managing information 350 uploaded by the terminal 50B.

In the first to third exemplary embodiments, in addition to exchanging the server storage 33, 33A and 33B, the restoration process in which the content data 340 and the reproduction schedule data 341 are acquired from the terminals 50, 50A and 50B to be stored in the server storage 33, 33A and 33B may be performed when a part of the content data 340 and the reproduction schedule data 341 in the server storages 33, 33A and 33B is destroyed or unintentionally deleted.

Further, in the first to third exemplary embodiments, the servers 30, 30A and 30B may request restoration to all or any of the terminals 50, 50A and 50B even without the query polling for new content from the terminals 50, 50A and 50B.

The invention may be applied for restoring a system for distributing document data, drawing data, presentation data and the like made by application software.

Further, the data processing device of the invention may be a mobile or a mounted personal computer, a mobile phone, a portable terminal such as a PDA (Personal Digital Assistant) and a display device for business information and in-vehicle information.

Though the above-described functions are provided by programs, the functions may alternatively be provided by hardware such as a circuit board, an IC (Integrated Circuit), or in any other form. Incidentally, by providing the functions by programs or reading the functions separately from a recording medium, the handling can be facilitated and use can be easily expanded, as described above.

The specific structure and procedure for implementing the invention may be altered in other fashion as necessary as long as an object of the invention can be achieved.

### ADVANTAGEOUS EFFECT OF EMBODIMENT

As described above, the server 30 of the advertisement distribution system 1 allows downloading of the content data 340 in response to the request of the terminal 50 and makes the terminal 50 periodically download the shared content managing information 350. Then, when the server 30 recognizes that the content data 340 stored in the server storage 33 before the server storage goes out of order has to be stored in a new server storage 33 (restoration process), the server 30 makes the terminal 50 upload the shared content managing information 350 and acquires from the terminal 50 the content data 340 specified by the shared content managing information 350 to store the content data 340 in the new server storage 33.

Thus, since the content data 340 to be reproduced in, for instance, the group A is distributed to the first to third terminals 51 to 53 without dividing, it is not necessary to divide the content data 340 as in a typical arrangement. Further, when, for instance, the first terminal 51 goes out of order, all of the content data 340 of the group A can be acquired from the second and third terminals 52 and 53 and the server 30 can store the content data 340 in the new server storage 33. In addition, since the content data 340 is acquired based on the shared content managing information 350 reflecting the storing status in the server storage 33, old content data 340 not necessary for the restoration process is not uploaded. Thus, the server storage 33 can be appropriately restored with a simple control.

### INDUSTRIAL APPLICABILITY

The present invention is applicable as a data distribution device, a data processing device, a data processing system, a data distribution method and a data processing method.

### EXPLANATION OF CODES

1, 1A, 1B . . . advertisement distribution system (data processing system)
2 . . . network
30, 30A, 30B . . . server (data distribution device, second computer)
33, 33A, 33B . . . server storage (distributor storage, restoration target storage)
51,52,53,54,55,56,51A,52A,53A,54A,55A,56A,51B,52B,53B,54B,55B,56B . . . first, second, third, fourth, fifth and sixth terminals (data processing device, first computer)
63, 63A, 63B . . . terminal storage (processing-side storage)
340 . . . content data constituting distribution data
341 . . . reproduction schedule data (process schedule data constituting distribution data)
344A . . . upload target information (transmission target information)
350 . . . shared content managing information (distribution data management information)
402 . . . distribution data distributor
403 . . . management information distributor
403A . . . management information distributor serving also as transmission target information sending unit
411 . . . server restoration status management unit (restoration status information generator)
412, 412A, 412B . . . restoration storage controller (storage controller serving also as distribution-side management information acquirer)
413B . . . restoration schedule creating unit (transmission target information sending unit)
661 . . . distribution data accumulating unit
662 . . . management information accumulating unit (processing-side management information acquirer)
671 . . . terminal restoration status management unit (restoration status information acquirer)
672, 672A . . . restoration procedure controller (distribution data returning unit)

1: An advertisement distribution device that is connected via a network to a plurality terminals configured to reproduce content data for advertisement contained in distribution data, the advertisement distribution device distributing the distribution data stored in a distributor storage to the plurality of terminals, the advertisement distribution device comprising:
a distribution data distributor that is configured to distribute the distribution data in the distributor storage to the plurality of terminals;
a management information distributor that is configured to distribute distribution data management information that is configured to specify the distribution data stored in the distributor storage to the plurality of terminals;
a distribution-side management information acquirer that, upon judging that the distribution data specifiable by the distribution data management information is necessary to be stored in a restoration target storage provided by the distributor storage or another distributor storage, is configured to acquire the distribution data management information from the plurality of terminals and to store the distribution data management information in the restoration target storage; and
a storage controller that is configured to acquire the distribution data specified based on the distribution data management information in the restoration target storage from the terminals and to store the distribution data in the restoration target storage, wherein
the distribution data management information comprises: content name information storing a content name of the content data; terminal list information storing a name of the terminal for the distribution data to be distributed; and timestamp information relating to time and date when the content name information and the terminal list information are generated or updated,
when it is judged that the distribution data management information acquired from the terminals is newer than the distribution data management information in the restoration target storage based on the timestamp information, the distribution-side management information acquirer updates the distribution data management information in the restoration target storage to the acquired distribution data management information, and
the storage controller acquires the distribution data comprising the content data specified by the content name information from the terminals specified by the terminal list information based on the distribution data management information in the restoration target storage.

2: The advertisement distribution device according to claim 1, further comprising:
a restoration status information generator that is configured to send restoration status information relating to a storing status of the distribution data in the restoration target storage to the plurality of terminals, wherein
the storage controller is configured to acquire from the plurality of terminals the distribution data that has been distributed to the plurality of terminals but not stored in the restoration target storage based on the restoration status information and to store the distribution data in the restoration target storage.

3: The advertisement distribution device according to claim 1, further comprising:
a transmission target information sending unit that is configured to send to the plurality of terminals transmission target information requesting transmission of at least one of the distribution data specifiable by the distribution data management information in the restoration target storage before recognizing that the distribution data has to be stored in the restoration target storage, wherein
the storage controller acquires the distribution data specified based on the transmission target information from the plurality of terminals and stores the distribution data in the restoration target storage.

4: The advertisement distribution device according to claim 1, further comprising:
a transmission target information sending unit that is, after the distribution data management information is updated by the distribution-side management information acquirer, configured to send to the terminals transmission target information requesting transmission of at least one of the distribution data specifiable by the updated distribution data management information, wherein
the storage controller acquires the distribution data specified based on the transmission target information from the plurality of terminals and stores the distribution data in the restoration target storage.

5: The advertisement distribution device according to claim 3, wherein
the distribution data distributor distributes a plurality of predetermined number of the distribution data to each of the plurality of terminals, and
the transmission target information sending unit requests the plurality of terminals to send less than the predetermined number of the distribution data and sends the transmission target information that is configured to acquire all of the predetermined number of the distribution data by the storage controller in response to the request.

6: The advertisement distribution device according to claim 1, wherein
the plurality of terminals belong to at least one of a plurality of groups, the content data to be reproduced by each of the groups being different,
the distribution data distributor distributes only the content data to be reproduced by predetermined one of the groups to each of the plurality of terminals belonging to the predetermined one of the groups, and
the management information distributor distributes to the plurality of terminals the distribution data management information that is configured to specify all of the distribution data stored in the distribution-side storage and respective destinations of the all of the distribution data.

7. (canceled)

8: The advertisement distribution device according to claim 1, wherein
the distribution data includes reproduction schedule data of the content data in the terminals.

9: A terminal that is connected to an advertisement distribution device configured to distribute distribution data stored in a distributor storage via a network, the terminal storing and processing the distribution data, the terminal comprising:
a distribution data accumulating unit that is configured to acquire the distribution data from the advertisement distribution device and to store the distribution data in a processing-side storage;
a reproduction device that is configured to reproduce content data for advertisement contained in the distribution data of the processing-side storage;
a processing-side management information acquirer that is configured to acquire from the advertisement distribution device distribution data management information that is configured to specify the distribution data in the distributor storage and to store the distribution data management information in the processing-side storage;
a distribution data returning unit that, when it is necessary to store the distribution data specifiable by the distribution data management information in a restoration target storage provided by the distributor storage or another distributor storage, is configured to return the distribution data management information in the processing-side storage to the advertisement distribution device;
a restoration status information acquirer that is configured to acquire restoration status information relating to a storing status of the distribution data in the restoration target storage from the advertisement distribution device; and
a restoration procedure controller that is configured to send the distribution data that is in the processing-side storage but not stored in the restoration target storage to the advertisement distribution device based on the restoration status information, wherein
the distribution data management information comprises: content name information storing a content name of the content data; terminal list information storing a name of the terminal for the distribution data to be distributed; and timestamp information relating to time and date when the content name information and the terminal list information are generated or updated, and
the restoration status information acquirer acquires the restoration status information relating to the storing status of the distribution data in the restoration target storage based on the newest distribution data management information based on the timestamp information.

10: An advertisement distribution system comprising:
a plurality of terminals that are configured to process distribution data; and
the advertisement distribution device according to claim 1, the advertisement distribution device being connected to the plurality of terminals via a network, wherein
the terminals each comprise:
a distribution data accumulating unit that is configured to acquire the distribution data from the advertisement distribution device and to store the distribution data in a processing-side storage;
a reproduction device that is configured to reproduce content data contained in the distribution data of the processing-side storage;
a processing-side management information acquirer that is configured to acquire the distribution data management information from the advertisement distribution device and to store the distribution data management information in the processing-side storage;
a distribution data returning unit that is configured to return the distribution data management information in the processing-side storage to the advertisement distribution device when it is necessary to store the distribution data specifiable by the distribution data management information in the restoration target storage; and
a restoration procedure controller that is configured to send the distribution data in the processing-side storage to the advertisement distribution device.

11: An advertisement distribution system comprising:
a terminal that is connected to an advertisement distribution device configured to distribute distribution data stored in a distributor storage via a network, the terminal storing and processing the distribution data, the terminal comprising: a distribution data accumulating unit that is configured to acquire the distribution data from the advertisement distribution device and to store the distribution data in a processing-side storage; a reproduction device that is configured to reproduce content data for advertisement contained in the distribution data of the processing-side storage; a processing-side management information acquirer that is configured to acquire from the advertisement distribution device distribution data management information that is configured to specify the distribution data in the distributor storage and to store the distribution data management information in the processing-side storage; a distribution data returning unit that, when it is necessary to store the distribution data specifiable by the distribution data management information in a restoration target storage provided by the distributor storage or another distributor storage, is configured to return the distribution data management information in the processing-side storage to the advertisement distribution device; a restoration status information acquirer that is configured to acquire restoration status information relating to a storing status of the distribution data in the restoration target storage from the advertisement distribution device; and a restoration procedure controller that is configured to send the distribution data that is in the processing-side storage but not stored in the restoration target storage to the advertisement distribution device based on the restoration status information, wherein the distribution data management information comprises: content name information storing a content name of the content data; terminal list information storing a name of the terminal for the distribution data to be distributed; and timestamp information relating to time and date when the content name information and the terminal list information are generated or updated, and the restoration status information acquirer acquires the restoration status information relating to the storing status of the distribution data in the restoration target storage based on the newest distribution data management information based on the timestamp information; and
the advertisement distribution device according to claim 2, the advertisement distribution device being connected to a plurality of the terminals via a network.

12: An advertisement distribution system comprising:
a plurality of terminals; and
the advertisement distribution device according to claim 3, the advertisement distribution device being connected to the plurality of terminals via a network, wherein
the terminals each comprise:
a distribution data accumulating unit that is configured to acquire the distribution data from the advertisement distribution device and to store the distribution data in a processing-side storage;
a reproduction device that is configured to reproduce content data contained in the distribution data of the processing-side storage;
a processing-side management information acquirer that is configured to acquire the distribution data management information from the advertisement distribution device and to store the distribution data management information in the processing-side storage;
a distribution data returning unit that is configured to return the distribution data management information in the processing-side storage to the advertisement distribution device when it is necessary to store the distribution data specifiable by the distribution data management information in the restoration target storage; and
a restoration procedure controller that is configured to acquire the transmission target information from the advertisement distribution device and to send the distribution data requested by the transmission target information to the advertisement distribution device.

13: An advertisement distribution method using a computer, connected to a plurality of terminals configured to reproduce content data for advertisement contained in distribution data via a network, to distribute the distribution data stored in a distributor storage to the plurality of terminals, the method comprising:
distributing, the distribution data in the distributor storage to the plurality of terminals;
distributing distribution data management information that is configured to specify the distribution data in the distributor storage to the plurality of terminals;
upon judging that the distribution data specifiable by the distribution data management information is necessary to be stored in a restoration target storage provided by the distributor storage or another distributor storage, acquiring the distribution data management information from the plurality of devices terminals and storing the distribution data management information in the restoration target storage; and
after acquiring the distribution data specified based on the distribution data management information in the restoration target storage, storing the distribution data in the restoration target storage, wherein
the distribution data management information comprises: content name information storing a content name of the content data; terminal list information storing a name of the terminal for the distribution data to be distributed; and timestamp information relating to time and date when the content name information and the terminal list information are generated or updated,
when it is judged that the distribution data management information acquired from the terminals is newer than the distribution data management information in the restoration target storage based on the timestamp information, the distribution data management information in the restoration target storage is updated to the acquired distribution data management information in the acquiring of the management information, and
the distribution data comprising the content data specified by the content name information is acquired from the terminals specified by the terminal list information in the storing of the distribution data based on the distribution data management information in the restoration target storage.

14: A data processing method using a computer, connected to an advertisement distribution device configured to distribute distribution data stored in a distributor storage via a network, to process the distribution data, the method comprising:
after acquiring the distribution data from the advertisement distribution device, storing the distribution data in a processing-side storage;
reproducing content data for advertisement contained in the distribution data in the processing-side storage:
after acquiring from the advertisement distribution device distribution data management information that is configured to specify the distribution data in the distributor storage, storing the distribution data management information in the processing-side storage;
when it is necessary to store the distribution data specifiable by the distribution data management information in a restoration target storage provided by the distributor storage or another distributor storage, returning the distribution data management information in the processing-side storage to the advertisement distribution device;
acquiring restoration status information relating to a storing status of the distribution data in the restoration target storage from advertisement distribution device; and
sending the distribution data that is in the processing-side storage but not stored in the restoration target storage to the advertisement distribution device based on the restoration status information, wherein
the distribution data management information comprises: content name information storing a content name of the content data; terminal list information storing a name of the terminal for the distribution data to be distributed; and timestamp information relating to time and date when the content name information and the terminal list information are generated or updated, and
the restoration status information relating to the storing status of the distribution data in the restoration target storage is acquired in the acquiring of the restoration status information based on the newest distribution data management information based on the timestamp information.

15: A data processing method using a plurality of first computers that are configured to store and process distribution data; and a second computer that is connected to the plurality of first computers via a network, the method comprising:
distributing, by the second computer, the distribution data from a distributor storage to the plurality of first computers;
distributing, by the second computer, distribution data management information that is configured to specify the distribution data in the distributor storage to the plurality of first computers;
upon judging that the distribution data specifiable by the distribution data management information is necessary to be stored in a restoration target storage provided by the distributor storage or another distributor storage, acquiring the distribution data management information from the plurality of first computers by the second computer to store the distribution data management information in the restoration target storage;
after acquiring the distribution data specified based on the distribution data management information in the restoration target storage from the first computers, storing the distribution data in the restoration target storage by the second computer;
after acquiring the distribution data from the second computer, storing the distribution data in a processing-side storage by the first computers;
reproducing content data for advertisement contained in the distribution data in the processing-side storage by the first computers;
after acquiring the distribution data management information from the second computer, storing the distribution data management information in the processing-side storage by the first computers;
when it is necessary to store in the restoration target storage the distribution data specifiable by the distribution data management information, returning, by the first computers, the distribution data management information in the processing-side storage to the second computer; and
sending the distribution data in the processing-side storage to the second computer by the first computers, wherein
the distribution data management information comprises: content name information storing a content name of the content data; terminal list information storing a name of the terminal for the distribution data to be distributed; and timestamp information relating to time and date when the content name information and the terminal list information are generated or updated,
in the acquiring of the distribution-side management information by the second computer, when it is judged that the distribution data management information acquired from the first computer is newer than the distribution data management information in the restoration target storage based on the timestamp information, the distribution data management information in the restoration target storage is updated to the acquired distribution data management information, and
the distribution data comprising the content data specified by the content name information is acquired from the first computer specified by the terminal list information in the storing of the distribution data based on the distribution data management information in the restoration target storage.

16: The advertisement distribution device according to claim 4, wherein
the distribution data distributor distributes a plurality of predetermined number of the distribution data to each of the plurality of terminals, and
the transmission target information sending unit requests the plurality of terminals to send less than the predetermined number of the distribution data and sends the transmission target information that is configured to acquire all of the predetermined number of the distribution data by the storage controller in response to the request.

17: An advertisement distribution system comprising:
a plurality of terminals; and
the advertisement distribution device according to claim 4, the advertisement distribution device being connected to the plurality of terminals via a network, wherein
the terminals each comprise:
a distribution data accumulating unit that is configured to acquire the distribution data from the advertisement distribution device and to store the distribution data in a processing-side storage;
a reproduction device that is configured to reproduce content data contained in the distribution data of the processing-side storage;
a processing-side management information acquirer that is configured to acquire the distribution data management information from the advertisement distribution device and to store the distribution data management information in the processing-side storage;
a distribution data returning unit that is configured to return the distribution data management information in the processing-side storage to the advertisement distribution device when it is necessary to store the distribution data specifiable by the distribution data management information in the restoration target storage; and
a restoration procedure controller that is configured to acquire the transmission target information from the advertisement distribution device and to send the distribution data requested by the transmission target information to the advertisement distribution device.

18: An advertisement distribution system comprising:
a plurality of terminals; and
the advertisement distribution device according to claim 5, the advertisement distribution device being connected to the plurality of terminals via a network, wherein
the terminals each comprise:
a distribution data accumulating unit that is configured to acquire the distribution data from the advertisement distribution device and to store the distribution data in a processing-side storage;
a reproduction device that is configured to reproduce content data contained in the distribution data of the processing-side storage;
a processing-side management information acquirer that is configured to acquire the distribution data management information from the advertisement distribution device and to store the distribution data management information in the processing-side storage;
a distribution data returning unit that is configured to return the distribution data management information in the processing-side storage to the advertisement distribution device when it is necessary to store the distribution data specifiable by the distribution data management information in the restoration target storage; and
a restoration procedure controller that is configured to acquire the transmission target information from the advertisement distribution device and to send the distribution data requested by the transmission target information to the advertisement distribution device.

19: An advertisement distribution system comprising:
a plurality of terminals; and
the advertisement distribution device according to claim 16, the advertisement distribution device being connected to the plurality of terminals via a network, wherein
the terminals each comprise:
a distribution data accumulating unit that is configured to acquire the distribution data from the advertisement distribution device and to store the distribution data in a processing-side storage;
a reproduction device that is configured to reproduce content data contained in the distribution data of the processing-side storage;
a processing-side management information acquirer that is configured to acquire the distribution data management information from the advertisement distribution device and to store the distribution data management information in the processing-side storage;
a distribution data returning unit that is configured to return the distribution data management information in the processing-side storage to the advertisement distribution device when it is necessary to store the distribution data specifiable by the distribution data management information in the restoration target storage; and
a restoration procedure controller that is configured to acquire the transmission target information from the advertisement distribution device and to send the distribution data requested by the transmission target information to the advertisement distribution device.
